(19) United States
(12) Patent Application Publication
(10) Pub. No.: US 2015/0227869 A1
(43) Pub. Date: Aug. 13, 2015

(54) RISK SELF-ASSESSMENT TOOL

(71) Applicant: BANK OF AMERICA CORPORATION, Charlotte, NC (US)

(72) Inventors: Asish Saraf, Mumbai (IN); Srishti Sethi, New Delhi (IN); Venkataramana Kalivarapu, Hyderabad (IN)

(73) Assignee: BANK OF AMERICA CORPORATION, Charlotte, NC (US)

(21) Appl. No.: 14/176,854

(22) Filed: Feb. 10, 2014

(51) Int. Cl. G06Q 10/06

(52) U.S. Cl. CPC G06Q 10/0635

(57) ABSTRACT

A method for using a risk self-assessment tool may include soliciting risk information from a business unit about a process subject to a risk, communicating the risk information to a risk assessment system, and/or performing a risk self-assessment process by selecting one or more parameters for inclusion on one or more user interface templates. The risk assessment system may determine a risk score associated with the process based on the risk information received from the business unit, and communicate the risk score to a user for approval. After approval, the risk self-assessment tool may communicate information about an approved risk management project to a second user, the risk management project including at least one control designed to mitigate a risk identified by the risk assessment system. The method may include creating, via the user interface device, a risk self-assessment questionnaire for soliciting information about a business process subject to risk.

### BACKGROUND

Governments, organizations, and other entities often implement processes in which one or more different types of risk may be involved. As such entities grow and implement an increasing number of processes, evaluating the different types of risk involved in such processes may become complex.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

A method for using a risk self-assessment tool of a risk self-assessment computing device may include soliciting risk information from a business unit about a process subject to a risk and communicating the risk information to a risk assessment system via a network. The risk assessment system may determine a risk score associated with the process based on the risk information received from the business unit. The risk self-assessment tool may communicate the risk score to a user that may be responsible for approving a risk management project associated with the process subject to the risk. After approval has been granted, the risk self-assessment tool may communicate information about an approved risk management project to a second user within the business unit, the risk management project including at least one control designed to mitigate a risk identified by the risk assessment system.

In some cases, a system to facilitate a risk self-assessment process may include a risk assessment system, an issue management system and a risk self-assessment computer device. The risk assessment system may include a computer device configured to assess a risk associated with a business process. The issue management system may be communicatively coupled to the risk assessment system such that the issue management system may be configured to manage a risk management project for mitigating the risk associated with the business process. In some cases, the risk self-assessment computer device, which may be communicatively coupled to the risk assessment system and the issue management system, may include a user interface having at least one user interface screen, a processor communicatively coupled to the user interface, and a non-transitory memory device communicatively coupled to the user interface and the processor. The memory device may store instructions, when executed by the processor, cause the risk self-assessment computer device to solicit risk information from a business unit about a process subject to a risk via a first user interface screen and communicate the risk information to the risk assessment system via a network. The risk assessment system may determine a risk score associated with the process based on the risk information received from the business unit. In some cases, the risk self-assessment computer device may report the risk score to a user via a second user interface screen. The user, via a user interface screen of the risk self-assessment computer device, may provide approval of a risk management project for mitigating the risk associated with the process. The instructions may further cause the risk self-assessment computer device to communicate, after approval has been granted, information about the risk management project to the issue management system and to solicit, via a user interface screen, a risk management decision about an approved risk management project. The risk management decision may include a choice between closing the risk management project, accepting the risk associated with the project and applying at least one control to the risk management project. In some cases, the at least one control may be designed to mitigate a risk identified by the risk assessment system.

In some cases, one or more computer readable media may have computer-executable instructions stored thereon that, when executed by one or more computers, cause the one or more computers to solicit risk information from a business unit about a process subject to a risk, communicate the risk information to a risk assessment system via a network, communicate the risk score to a user, the user responsible for approving a risk management project associated with the process subject to the risk, and after approval has been granted, communicate information about an approved risk management project to a user within the business unit. In some cases, the risk assessment system may determine a risk score associated with the process based on the risk information received from the business unit and the risk management process may include at least one control designed to mitigate a risk identified by the risk assessment system.

In some examples, a method for configuring a risk self-assessment tool of a risk self-assessment computing device for performing a risk self-assessment process may include selecting, via a template screen of a user interface device, one or more parameters for inclusion on one or more user interface templates. In some cases, the templates may be used for creating a risk self-assessment questionnaire for soliciting information about a business process subject to risk. The method may further include creating, via the user interface device, the risk self-assessment questionnaire corresponding to the particular business project using the one or more user interface templates.

Furthermore, in some cases, a system for configuring a risk self-assessment tool of a risk self-assessment computing device for performing a risk self-assessment process may include a risk self-assessment computing device. The risk self-assessment computing device may include a user interface having one or more user interface screens, a processor communicatively coupled to the user interface and a non-transitory memory in communication with one or more of the user interface and the processor. The non-transitory memory may store instructions that, when executed by the processor, cause the risk self-assessment computer device to select, via a template screen, one or more parameters for inclusion on one or more user interface templates and present, via the user interface device, a risk self-assessment questionnaire to a user, the questionnaire corresponding to the particular business project based on the one or more user interface templates.

In addition, in some cases, one or more computer readable media may have computer-executable instructions stored thereon that, when executed by one or more computers, cause the one or more computers to select, via a template screen of a user interface device, one or more parameters for inclusion on one or more user interface templates and create, via the user interface device, a risk self-assessment questionnaire corresponding to the particular business project using the one or more user interface templates.

According to one or more additional aspects, a risk scorecard may be generated, and the risk scorecard may visually depict each of the at least one risk parameter score and the overall risk score for the at least one process.

### BRIEF DESCRIPTION OF THE DRAWINGS

The present disclosure is illustrated by way of example and not limited in the accompanying figures in which like reference numerals indicate similar elements and in which:

FIG. 1A illustrates a suitable operating environment in which various aspects of the disclosure may be implemented;

FIG. 1B illustrates a suitable system in which various aspects of the disclosure may be implemented;

FIG. 2 illustrates a suitable network environment in which various aspects of the disclosure may be implemented;

FIG. 3 illustrates a sample block diagram of a risk management environment according to one or more aspects described herein;

FIG. 4 illustrates a sample method of risk self-assessment of a process according to one or more aspects described herein;

FIG. 5 illustrates a sample method for configuring a risk self-assessment tool to facilitate creation of a risk management project according to one or more aspects described herein;

FIGS. 6-13 illustrate sample user interfaces for configuring a risk self-assessment tool according to one or more aspects described herein;

FIG. 14 illustrates a block diagram representation for using a risk self-assessment tool to generate a risk management project according to one or more aspects described herein;

FIGS. 15-19 illustrate sample user interface screens for facilitating creation of a risk management project according to one or more aspects described herein;

FIG. 20 illustrates a sample workflow for a risk management process according to one or more aspects described herein; and

FIG. 21 illustrates a sample method for managing a risk according not one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized and structural and functional modifications may be made, without departing from the scope of the present disclosure.

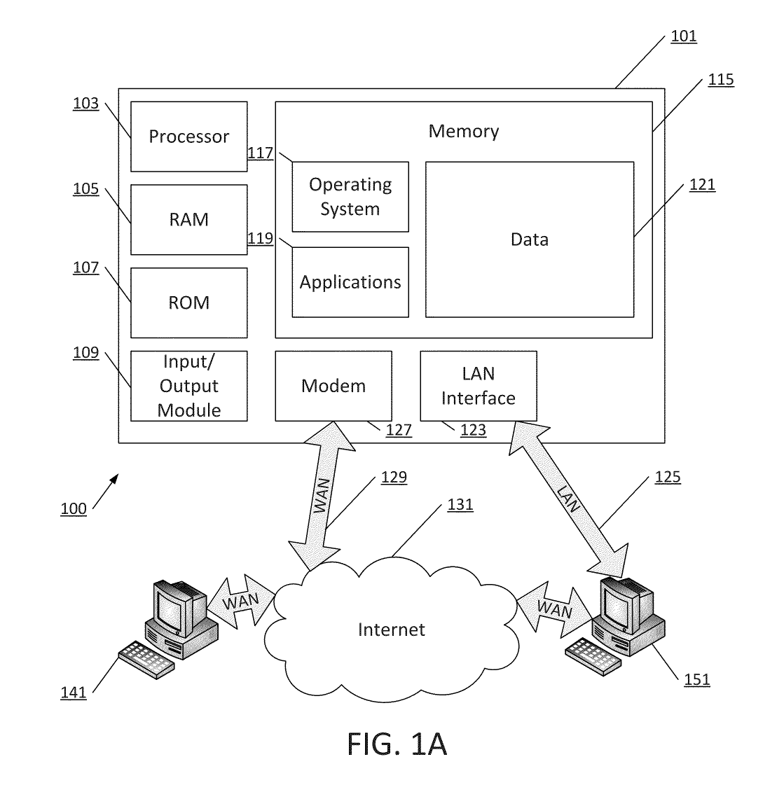

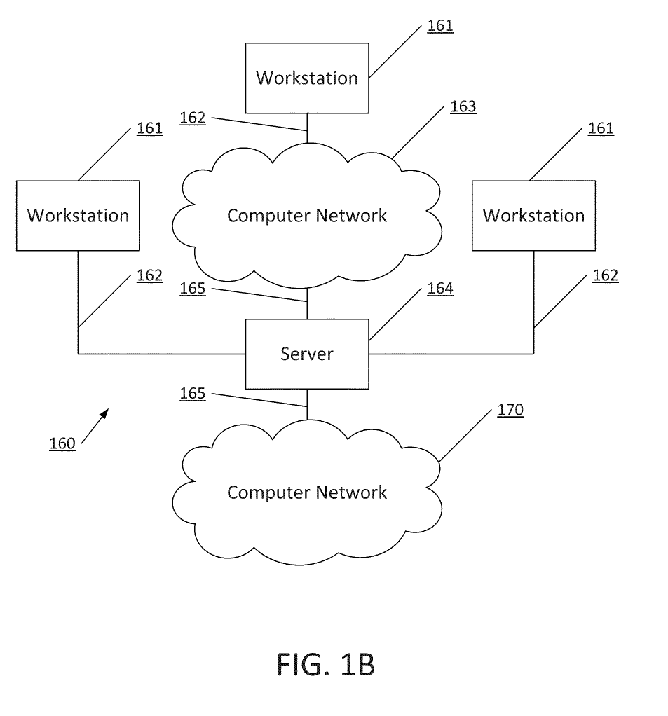

FIG. 1A illustrates a block diagram of a generic computing device 101 (e.g., a computer server) in computing environment 100 that may be used according to one or more illustrative embodiments of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual, and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of the computer executable instructions for server 101 may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, and the like) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates a suitable system 160 in which various aspects of the disclosure may be implemented. As illustrated, system 160 may include one or more workstations 161. Workstations 161 may be local or remote, and may be connected by one or communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

Computer network 163 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 162 and 165 may be any communications links suitable for communicating between workstations 161 and server 164, such as network links, dial-up links, wireless links, hard-wired links, and the like

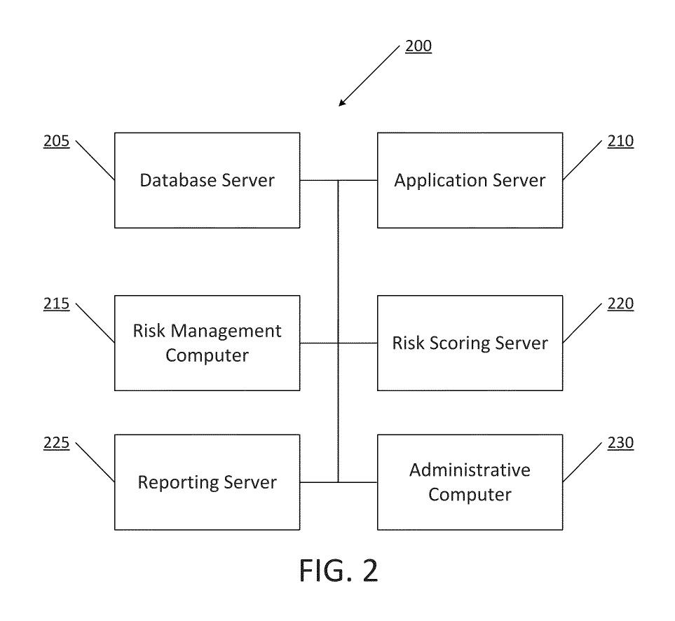

FIG. 2 illustrates a suitable network environment in which various aspects of the disclosure may be implemented. Network environment 200 may include several computing devices. For example, network environment 200 may include database server 205, application server 210, risk management computer 215, risk scoring server 220, reporting server 225, and administrative computer 230.

In one or more arrangements, database server 205 may store information about one or more processes, previously measured and/or analyzed historical process data, risk management information, one or more computation preferences (e.g., user-defined weights to be assigned to various types of information in analyzing risk), one or more risk reports (e.g., one or more risk scorecards and/or one or more risk heat maps), administrative data, and/or other information and/or data as further described herein. For example, database server 205 may store historical process data, which may enable a system implementing one or more aspects of the disclosure to calculate a regression and/or perform trend analysis. Such a calculation may be used, for instance, in determining a likelihood score for a risk element, as further described below.

In at least one arrangement, application server 210 may receive and/or store information about one or more risk elements, risk categories, and/or risk parameters; determine one or more exposure scores, impact scores, and/or likelihood scores; determine one or more risk element scores, risk category scores, and/or risk parameter scores; and/or otherwise process data related to risk evaluation. For example, application server 210 may receive and/or store information that may be used in determining an exposure score, an impact score, and/or a likelihood score for a risk element, and application server 210 subsequently may determine such scores, as well as an overall element score, for the risk element.

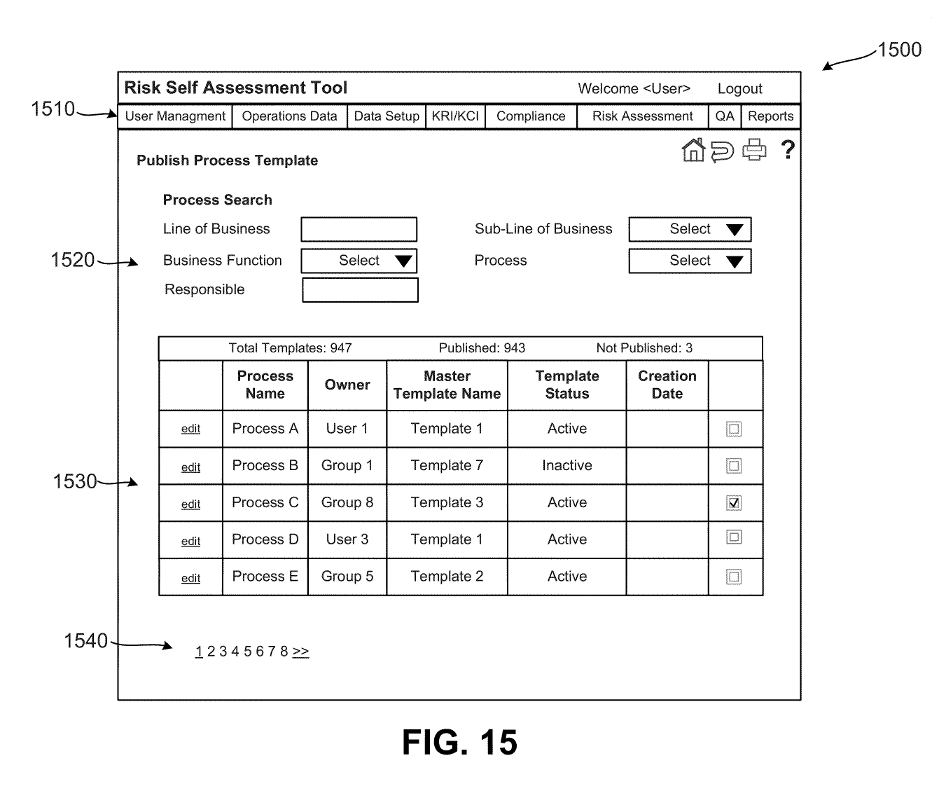

In at least one arrangement, risk management computer 215 may generate and/or display one or more user interfaces related to risk management generally, including user interfaces related to one or more processes, one or more risk elements, one or more risk categories, one or more risk parameters, one or more risk assessments, one or more risk reports (e.g., one or more risk scorecards and/or one or more risk heat maps), and/or other information. For example, the risk management computer 215 may generate and/or display a user interface allowing a user, such as a risk manager, to enter input that may be used in calculating an exposure score and/or conducting a risk assessment for a particular business process. Such a user interface, for instance, may include one or more attributes similar to those of the sample user interfaces illustrated in FIGS. 15-19, which are further described below.

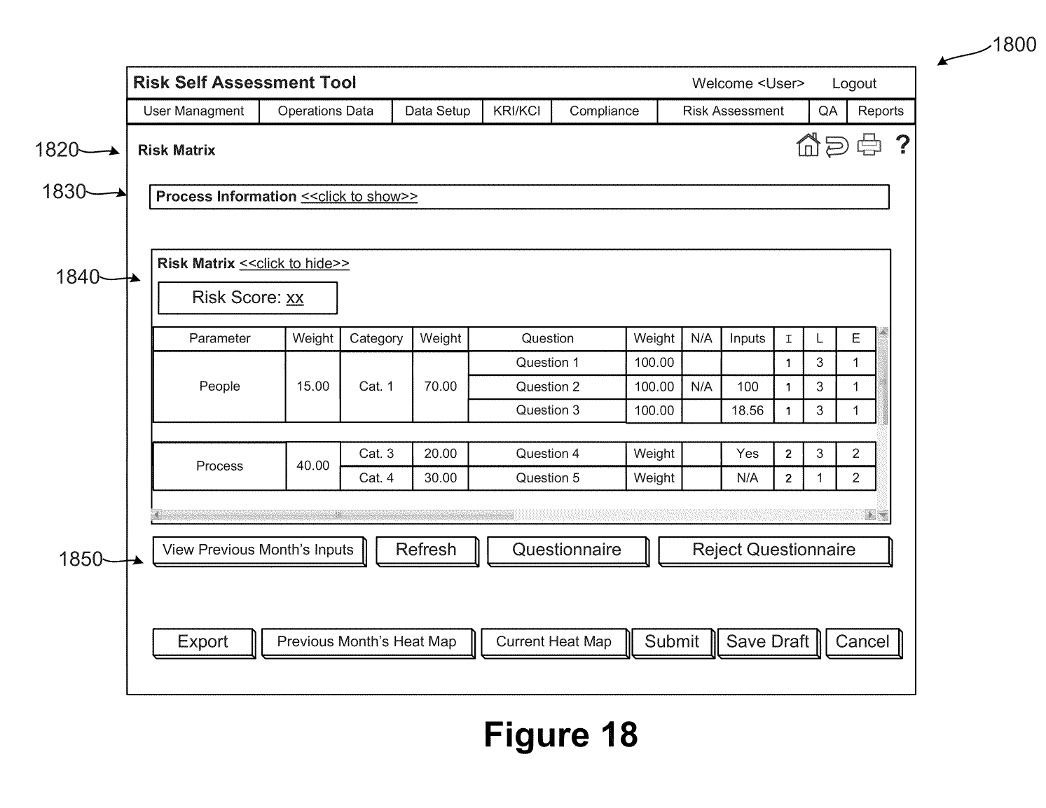

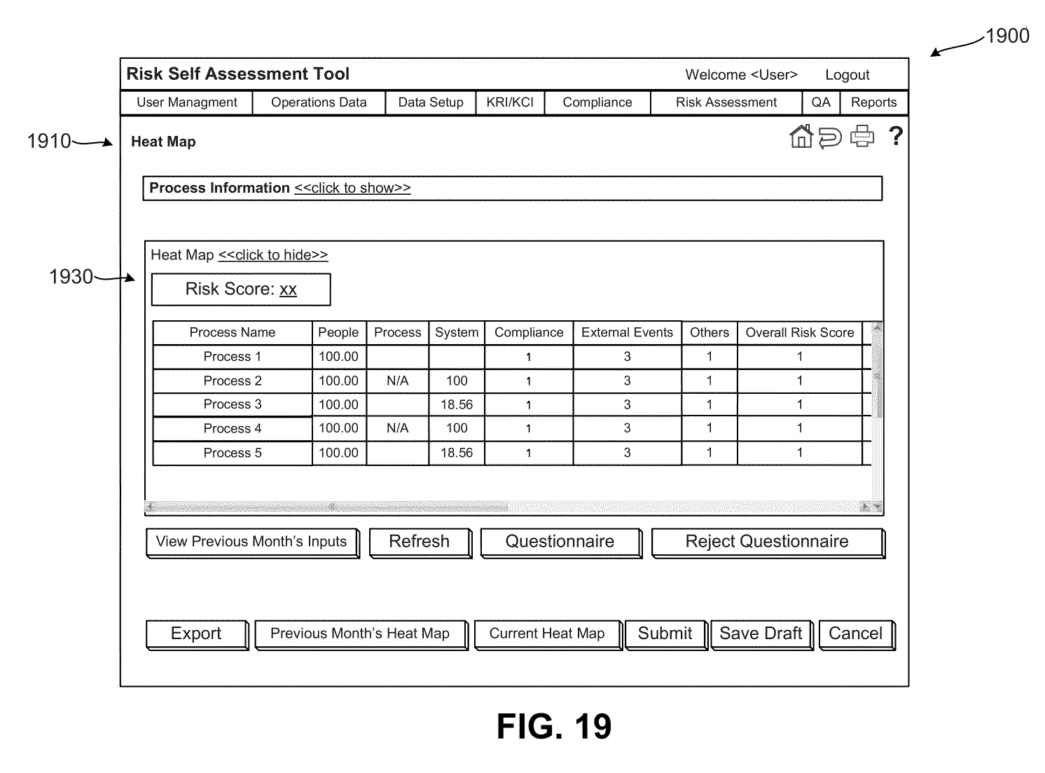

In at least one arrangement, risk scoring server 220 may receive and/or store information about one or more risk elements, risk categories, and/or risk parameters; determine one or more risk element scores, risk category scores, and/or risk parameter scores; aggregate and/or analyze information related to one or more risk element scores, risk category scores, and/or risk parameter scores; and/or otherwise process data related to risk evaluation. For example, risk scoring server 220 may aggregate and/or analyze one or more risk parameter scores for a plurality of business processes implemented and/or managed by a plurality of internal divisions, and such aggregation and/or analysis may be used in producing one or more risk reports. For instance, a risk report (e.g., a risk scorecard) may include aggregated and/or analyzed information about one or more risk parameters, as may be seen in the sample user interfaces illustrated in FIGS. 18 and 19, which are further described below.

In at least one arrangement, reporting server 225 may receive, analyze, and/or store information about one or more risk elements, risk categories, and/or risk parameters, including aggregated and/or analyzed information; generate and/or display one or more risk reports (e.g., one or more risk scorecards and/or one or more heat maps); and/or otherwise process and/or display data related to risk evaluation. For example, reporting server 225 may receive aggregated and/or analyzed information related to one or more risk parameters; may generate, based on such information, one or more risk assessments and/or one or more action items; and subsequently may generate and/or display a risk report (e.g., a risk scorecard) that includes the aggregated and/or analyzed information related to the one or more risk parameters, the one or more generated risk assessments, and/or the one or more generated action items. For instance, reporting server 225 may generate a risk report (e.g., a risk score) similar to those of the sample user interfaces illustrated in FIGS. 18 and 19, which are further described below.

In at least one arrangement, administrative computer 230 may generate one or more user interfaces related to system configuration, system status, system logs, and/or other information. Such user interfaces, for example, may enable a user to configure and/or interact with a system implementing one or more aspects of the disclosure.

While network environment 200 is described as including various computers adapted to perform various functions, it should be understood that the system may be modified to include a greater or lesser number of computers which may be used alone or in combination to provide the same functionality. For example, a single computer may be used to perform all of the functions described, and one or more users may interact with the single computer through one or more terminals and/or user interfaces. In another example, a first computer may be used to perform all of the functions of database server 205 and application server 210, a second computer may be used to perform all of the functions of risk management computer 215 and risk scoring server 220, and a third computer may be used to perform all of the functions of reporting server 225 and administrative computer 230. In addition, while various analyses are described with respect to various internal divisions within an organization, similar analyses may be performed with respect to a greater and/or lesser number of internal divisions and/or designations within an organization, such as a financial institution.

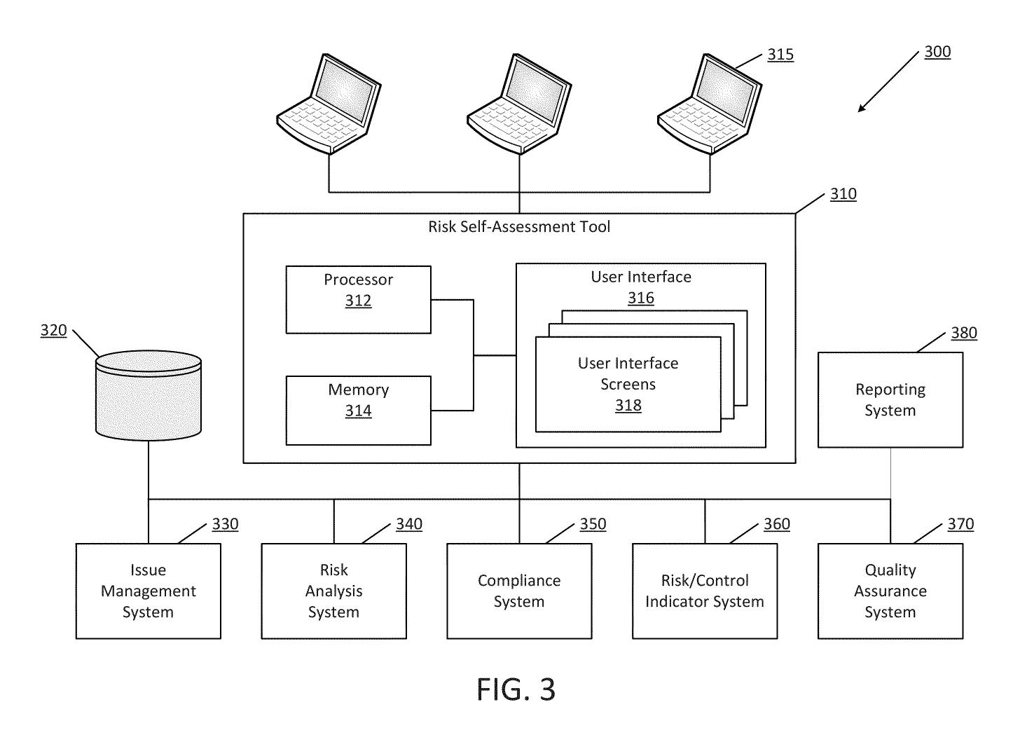

FIG. 3 illustrates a sample block diagram of a risk management system 300 according to one or more aspects described herein. In some cases, the risk management system 300 may include one or more computer device 315 that may be communicatively coupled via a communication link (e.g., the network 170, the communication links 162, 165, and the like) to a risk self-assessment tool 310. The risk self-assessment tool may comprise a risk self-assessment computer having one or more processors (312), one or more memory devices 314 and a user interface 316 that may be configured to solicit and/or display information via one or more user interface screens 318. The user interface 316 may be local to the risk self-assessment tool 310 and/or may be a remote user interface associated with another computer device, such as the computer devices 315. The risk self-assessment tool 310 may be communicatively coupled to one or more of a data repository 320, an issue management system 330, a risk analysis system 340, a compliance system 350, a risk indicator/control indicator system 360, a quality assurance system 370 and/or a reporting system 380. In some cases, the risk self-assessment tool 310 may be communicatively coupled to one or more computer devices (e.g., computer device 315) that a user may use to access and/or provide information to the risk management system. For example, the user may view one or more user interface screens 318 provided by the risk self-assessment tool 310 via a browser application. Any one of the above mentioned devices may comprise one or more computer devices discussed above in reference to FIGS. 1A, 1B, and 2, such as the computer device 101, the terminals 141, 151, the work stations 161, and/or the server 164. In some cases, the data repository 320 may be implemented using the database server 205. In other cases, the risk self-assessment tool 310 may operate on a risk self-assessment computing device, such as the risk management computer 215 and/or the application server 210. The risk analysis system 340 may further include a risk scoring server 220 for determining a risk score associated with a process risk. The one or more of the compliance system 350, the risk indicator/control indicator system 360, and/or the quality assurance system 370 may be implemented using one or more of the application server 210 and the administrative computer 230. In some cases, the reporting system 380 may include a reporting server 225 configured to report information from one or more other systems to a user.

As mentioned above, an organization (e.g., a corporation, a financial institution, a government entity, a health provider, and the like) may implement one or more processes, such as to facilitate different business activities. For example, a financial institution may include a customer support process which may be used to receive incoming telephone calls from customers and then may be routed to different customer service representatives. The customer service representatives may assist the customer in resolving issues with products and/or services provided by the financial institution. As an organization becomes larger and/or the processes become more complex, each business process may be subject to some level of risk. To mitigate these risks, the organizations may devise and/or use a risk mitigation process to control and/or track one or more different risk management projects. In doing so, user input may be sought. For example, a user of a process, and/or a manager of different project users may be capable of quickly assessing a perceived risk and quantifying the risk using different metrics. The user may then use one or more of the computer devices 315 to enter information and/or view information about a business process subject to a risk.

In some cases, the risk self-assessment tool 310 may be configured to facilitate end-to-end management of a risk mitigation project. For example, the risk self-assessment tool 310 may be used to gather information about a business process subject to a risk, present aggregated risk information to a user, create a risk management project and to monitor a lifecycle of the risk management project, and to report a status of the risk management project to the user. For example, the risk self-assessment tool 310 may be developed to automate a periodic (e.g., monthly, weekly, semi-annual, annual, and the like) process to assess a risk of different business processes. The risk self-assessment tool 310 may be used for data collection, tracking operational risk issues and/or reporting of one or more metrics and/or indicators (e.g., a key risk indicator, a key control indicator, and the like), a compliance status and/or the like. The risk self-assessment tool may be integrated with different systems (e.g., the systems 330-380) so that the risk management projects may be managed with minimal intervention. The risk self-assessment tool may store and/or retrieve data to/from the data repository 320. For example, current and/or historical process information, risk information, controls information may be stored in the data repository for later retrieval by the one or more of the systems 330-380 and/or the risk self-assessment tool 310. In some cases, the risk self-assessment tool may be scalable, or otherwise expandable, to be able to increase a number of processes supported and/or to facilitate performance of data analysis (e.g., a trend analysis of one or more different risk parameters). In some cases, the risk self-assessment tool 310 may be configured to quantify an expected outcome, such as by using one or more mathematical equations on past data and/or by tracking of the different risk issues.

The issue management system 330 may include a workflow that may have been created to automate the escalation, tracking and/or monitoring of issues identified through the risk assessment and management process defined herein. In some cases, the risk self-assessment tool 310 may be communicatively coupled to a risk analysis system 340 that may be configured to produce a risk score card. For example, the risk analysis system may be configured to provide an operational risk health indicator (e.g., a risk score) at a process level. In doing so, the risk assessment process may include measurement of metrics associated with one or more of people, process, and/or system parameters, compliance parameters, and/or the like. In some cases, the risk self-assessment tool 310 may communicate with a compliance system 350 to monitor compliance to at least one of a regulation (e.g., a state law, a federal law, and the like). The compliance system 350 may be capable of determining a composite compliance risk score at a project level. In some cases, the compliance system 350 may have the ability to determine the metric performance at the project level and, in some cases, at a higher level within the organization (e.g., a business group, a business segment, a line of business, and the like).

The risk/control indicator system 360 may be used to define and/or track indicators (e.g., a key risk indicator, a key control indicator, and the like) at the process level. In some cases, these indicators may provide a view of the control performance (e.g., the performance of a risk mitigation control process), as well as a level of risk for each of one or more different business processes. In some cases, the system 300 may include a control inventory, which may be included as a portion of the data repository 320 and/or may be separate from the data repository 320. The one or more controls stored in the control inventory may be used to define a control environment by maintaining and/or creating an inventory of known risks and associated controls.

The data repository 320 may be configured to store information about one or more business processes, one or more metric definitions for one or more metrics, approval information for one or more metrics, previously measured and/or analyzed historical process data, risk management information, one or more risk scores, one or more compliance reports, administrative data and/or other information and/or data described herein. For example, the data repository may store historical process data that may be used perform one or more calculations. For example, the historical information and/or current data may be analyzed to calculate a regression, a trend analysis, a risk score, a compliance score, a key control indicator metric, a key risk indicator metric, and/or the like. The quality assurance system 370 may be used to monitor and/or test the different risk processes and/or any associated controls that are designed to mitigate the risk. The system 300 may further include a reporting system 380. The reporting system 380 may include the capability to generate one or more reports associated with the different risk management projects. For example, the reporting system 380 may be configured to output a report about a risk metric, a compliance metric, a key risk indicator metric, a key control indicator metric, and/or the like. In some cases, a report may be generated and/or displayed by one or more user interface screens 318 of the risk self-assessment tool 310. A report may include an email, a visual presentation on a user interface screen 318, an audio presentation, a spreadsheet, a slide deck, and/or the like.

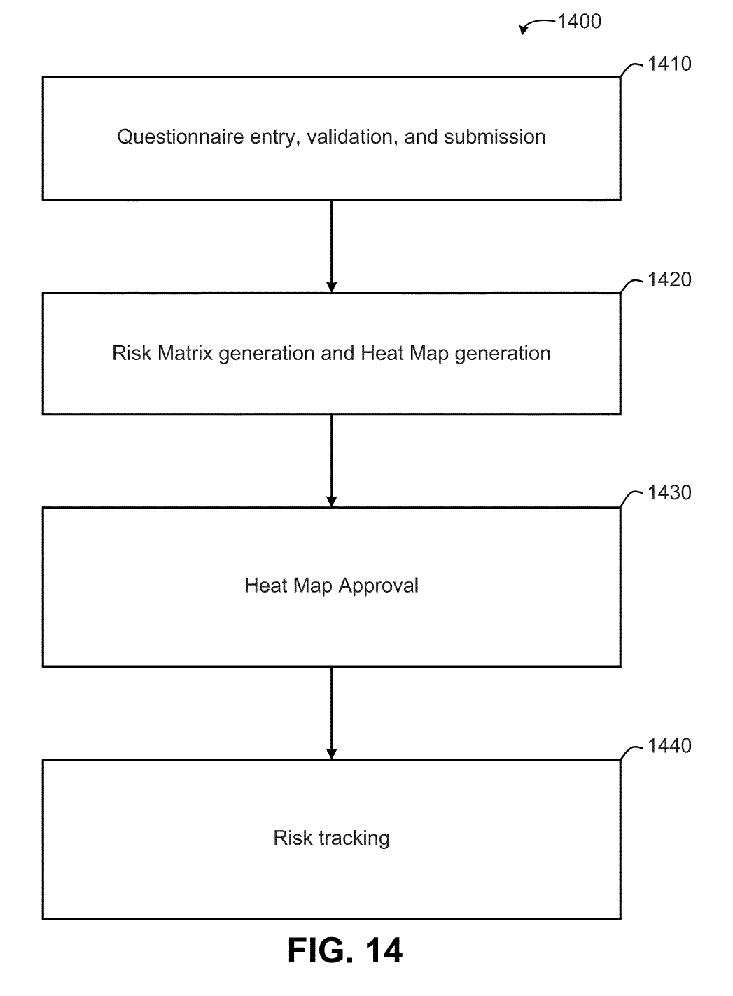

The different components of the system 300 may be used to monitor and/or mitigate risk associated with different business processes, such as the method 1400 shown in of FIG. 14. To determine a level of risk associated with the project, the risk self-assessment tool 310 may solicit information from a user via the one or more interface screens 318. During the process, one or more different people may be responsible for a different aspect of the process. In some cases, the risk self-assessment tool 310 may be used to solicit information from at least one responsible party to be used in creating the risk management project. In some cases, the risk self-assessment tool 310 may be configured to solicit information about a risk management project, such as by soliciting information at regular intervals.

At 1410, the risk self-assessment tool 310 may present a questionnaire to a user to solicit information about the business project. For new risk management projects, a user may trigger the creation of the project by selecting, and filling out, a questionnaire customized for user by a particular business group and/or for use with a particular process. For managing existing risk management processes, the risk self-assessment tool 310 may email, or otherwise generate an alert indicating that a questionnaire may be scheduled to be filled out.

In some cases, a responsible user may be alerted by the risk self-assessment tool 310 by an email, a text message, a phone call, a printed report, and/or the like. In some cases, at least a portion of the questionnaire may be included with the alert. In other cases, a link, or other notification to access the questionnaire via the user interface 316 of the risk self-assessment tool 310. The responsible person may then fill out the questionnaire and submitting the questionnaire into the system, such as by storing the filled questionnaire in the data repository 320 and/or submitting the questionnaire to the risk analysis system 340. After this submission, a different alert may be sent to a different user, such as a process manager. The process manager may then validate the questionnaire and/or supplement the questionnaire by adding comments or metrics to the questionnaire before submission to the risk analysis system 340. After the validated questionnaire is submitted, a third alert may be generated and sent by the risk self-assessment tool 310 to a different person, such as a process owner and/or a risk manager. The process owner may validate and/or comment on the questionnaire. Once validated, the risk self-assessment tool may lock the questionnaire and publish the questionnaire for access by the risk analysis system 340. Once validates by the process owner, another alert may be sent to a risk manager. The risk manager may access the questionnaire via the risk self-assessment tool similarly to the other responsible persons. The risk manager may validate the parameters and comment sand then the risk self-assessment tool 310 may then submit the validated questionnaire to the risk analysis system 340. The risk self-assessment system 330 may then update a risk matrix and/or the heat map associated with the particular business process using the validated information on the questionnaire.

At 1420, the risk analysis system may send an alert, such as to the risk manager, that the risk matrix has been updated. The risk manager may then review the risk matrix in relation to the questionnaire and update any metrics (e.g., a risk likelihood metric, a risk impact metric, and/or a risk exposure metric), as necessary. The risk analysis system 340 may then update the heat map associated with the risk management project. In some cases, the risk analysis system 330 may use the reporting system 380 to generate a summary report about the risk management project. In some cases, an alert may be sent to a different manager, such as a senior risk manager. The senior risk manager may view the report, the heat map, the risk matrix, and/or any project information via one or more user interface screens 318 of the risk self-assessment tool. The senior risk manager may view a same report and/or summary as the other managers, or may receive a slightly different version. In some cases, the senior risk manager may view, or otherwise group a number of risk management projects associated with two or more processes associated with a business group, such that an alert may be sent to another person for approval.

At 1430, the risk analysis system 340 and/or the risk self-assessment tool 310 may send the alert to the risk management project approver. This person may view a summary, with and/or the heat map and adds comments as necessary. The risk project approver may then approve the heat map and/or the risk management project and/or reject the heat map. Upon a rejection, an alert or other notification may be sent to the risk manager for their review. The process owner may receive an alert from the risk self-assessment tool 310 so that the process owner may view and/or add comments to the risk management project summary.

At 1440, the risk management project may be communicated to the issue management system 330. For example, once the heat map has been approved the risk self-assessment tool 310 and/or the issue management system 330 may be configured to identify high and/or medium priority issues from the heat map. The issue management system 330 may then send one or more alerts to the risk manager to view the risk management project associated with the high and/or medium priority issues. The risk manger may then validate the issue tracker and an alert may then be sent to the process owner. The process owner may the n view and/or validate the issues generated by the issue management system 330 using the risk self-assessment tool 310. The process owner may then add comments to the issue tracker, such as by deciding on a mitigation plan and providing a closure date for the issue.

As discussed above, the risk self-assessment tool 310 was designed to allow a user to track the operational risk at a process level and/or to facilitate self-assessment by the business unit personnel on operational risk parameters, compliance metrics, key control indicators, and/or key risk indicators. For each operational risk parameter, an objective and/or quantitative measure may be used to determine a risk score by the risk analysis system 340 by determining a rating based on a likelihood of the risk occurring, an impact on the process and/or line of business resulting from the risk, and an exposure to the risk. For example, the likelihood corresponds to the possibility of the risk event occurring based, at least in part, on historical data that may be stored in the data repository 320. The impact may be a severity of the risk event based, at least in part, on customers affected by the risk, the reputation of the business as would be affected by the risk, and/or for any legal and/or regulatory impacts. The exposure metric may be a loss that may impact and/or exist in the business unit as a result of the risk.

The risk self-assessment tool 310 may be configured to examine the risk exposure of multiple business units at over a regular time period. For example, the risk self-assessment tool 310 may trigger a monthly review of each identified risk for the different business units of an organization. At the beginning of the month, a questionnaire associated with different elements of an operational risk and/or compliance issues associated with the identified risk may be provided to the responsible business unit teams. The team members may access the questionnaire via a user interface screen 318 of the risk self-assessment tool 310 to provide their input. The responses received may be communicated by the risk self-assessment tool 310 to the risk analysis system 340 for analysis based on different likelihood metrics, impact metrics and/or exposure metrics to determine a risk matrix and/or heat maps that show the “health” of an operational risk across the examined parameters. A report may be generated by the reporting system 380 and provided to the responsible business groups via the risk self-assessment tool 310 for their review. An illustrative project review cycle may include submission of the project risk questionnaire at the first working day of the month, validation of the report by the sixth working day of the month, a quality check for reviewing the process to be completed by the tenth working day of the month and reporting a risk score (e.g., a risk scorecard) associated with the project to be made available by the 15^{th} working day of the month.

As can be seen, the risk self-assessment tool may be used to provide centralized management and/or consolidation of different risk management projects across an organization (e.g., different business units, lines of business, different geographical locations, and the like). A user role may be managed and/or assigned through the risk self-assessment tool 310, where user roles may have particular roles and/or functions assigned. The risk self-assessment tool 310 may also be a web-based tool that may allow for different business units, at different geographical locations, to access a centralized system for managing different risk mitigation projects. An example of different user interface screens provided by the risk self-assessment tool 310 during this process are discussed below in reference to FIGS. 15-19.

The compliance system 350 may be used as a framework designed to measure compliance with one or more legal and/or regulatory requirements associated with a business activity of the business unit. Also, the compliance system 350 may measure compliance with one or more policies, procedures and/or standards of the business that may be applicable to the particular processes used by the business unit. For example, the compliance system 350 may be configured to measure different metrics associated with opportunities and/or defects affected by the business process based on different applicable laws, regulations, business policies, procedures and standards.

The risk self-assessment tool 310 may be used to identify compliance metrics at the process level using different documents, such as a matrix identifying applicable laws and/or regulations, a compliance program associated with a particular line of business, policy and/or procedural documents of a business segment, and/or other profess specific procedures and/or “toll gate” risk assessments. In some cases, the compliance metrics may be obtained by different “best practices” guidelines provided at an organizational level and/or compliance and/or operational risk parameter guidelines provided by a partner organization. The risk self-assessment tool 310 may allow a responsible user to identify and/or edit compliance metric information via one or more different user interface screens 318. For example, the user may provide metric definitions, define a time period that determines a frequency of reporting a particular metric (e.g., monthly, biweekly, and the like), design a data collection template used to solicit information about the metrics (e.g., a compliance questionnaire), define quality control parameters (e.g., sample metrics, volume of transaction metrics, and the like) and/or define a focus of which metrics to consider (e.g., define a weighting to be associated with each regulatory metric and/or procedural metric).

The risk self-assessment tool 310 may be used to report compliance information via a common centralized platform, where the data can be monitored and validated for accuracy. In some cases, a report may be generated, such as by the reporting system, that illustrates the “health” of the different metrics for each project and/or for groupings of risk management projects, such as via a monthly compliance “dashboard” screen summarizing the compliance ratings and/or metrics for different risk management projects. By using a centralized tool, such as the risk self-assessment tool 310, regulatory and/or procedural changes may be efficiently monitored to ensure that each risk management project is measured against the currently applicable law, regulation and/or policy. Further, the risk self-assessment tool 310 allows for different groups (e.g., business units, compliance partners such as regulatory bodies and/or standards organizations) to share in the compliance reports, such as via a web-based interface.

In some cases, the risk/control indicator system 360 may be used to measure and/or report measurements about the risk associated with the business process and/or the effectiveness of the controls being used to mitigate the risk. The key risk indicators may be used to monitor an organization's risk profile and/or a rate of change occurring to the risk of the different processes used by the business units. The key control indicator may be used to define a control environment while monitoring whether the controls used to mitigate a risk is operating within a defined tolerance. In other words, the key control indicator may be used to determine whether a particular control being used to mitigate a risk is operating as designed. In some cases, one or more key performance indicators may be used to determine whether a particular business process, such as the process subject to a risk, is performing as expected.

In an illustrative approach for monitoring one or more key risk indicators and/or key control indicators may include mapping one or more business processes and/or risk management projects to a workflow tool, such as the risk self-assessment tool 310. Once mapped, one or more different key risk indicators and/or key control indicators may be identified using the risk self-assessment tool 310. For example, the risk self-assessment tool 310 may provide one or more different user interface screens 318 via the user interface 316 such that a user may enter details about desired key risk indicators and/or key control indicators. The risk self-assessment tool 310 may also be used to define one or more parameters associated with each key risk indicator and/or key control indicator, such as a trigger condition, a limiting condition and/or a threshold condition. Once mapped and defined, the key risk indicators and/or the key control indicators may be monitored during the operation of the risk management project to determine whether one or more controls for mitigating the risk associated with the business process are working as expected. The risk self-assessment tool 310 and/or the reporting system 380 may provide reports that provide details about the status of each key risk indicator and/or each key control indicator.

In an illustrative example, a process used by a business unit may be included in a risk management project to mitigate one or more risks associated with the process. For example, the process may correspond to examination and/or negotiating a United States trade export document. Once entered, one or more risks and/or controls may be identified and may be associated with the risk management project. For example, risks associated with this process may include (1) transactions may remain pending without a valid reason or due to inadequate follow up with the responsible business unit, (2) a refusal may not be sent for discrepant documents and/or a refusal may have been sent to an incorrect party, and (3) errors in compliance may be reported by a business unit and/or may be identified during a quality control check conducted by a control team. After the risks and/or controls have been identified, one or more key control indicator metrics, key risk indicator metrics and/or associated thresholds and limits may be identified. For example, a first indicator may correspond to a lack of effective follow up on pending transactions, such as transactions pending without a valid reason and/or due to inadequate follow up. Another metric may correspond to refusal errors. For example, if a refusal has not been sent within a specified number of working days (e.g., about 5 days), then one or more business policies and/or regulations may not be met. Additionally, compliance errors may be used as a metric. For example, the risk self-assessment tool 310 may be configured to track a number of compliance errors reported by a business unit and/or identified during a quality control check of the process. The risk self-assessment tool 310 may provide status information regarding these key risk indicators and/or key control indicators to a user. As such, the user may better understand the risks associated with the process and/or risk mitigation strategies being used to mitigate these risks.

In some cases, the key risk indicator metrics and/or the key control indicator metrics may be reported via different methods including using one or more user interface screens 318 of the risk self-assessment tool. The reporting process may include mapping of controls and/or indicators (e.g., key control indicators, key risk indicators) to one or more risk management projects via dialogs and/or fields presented on a user interface screen 318. The risk self-assessment tool 310 may further allow a user to collect key risk indicator information and/or key control indicator information for two or more different processes and store the collected indicator information at a central location, such as the data repository 320. The risk self-assessment tool 310 may be used to present one or more reports using the collected key risk indicator information and/or the key control indicator information. For example, the risk self-assessment tool 310 may include one or more different user interface screens for presenting the information to a user, such as a first page for presenting an indicator report about a particular process and/or a second page for presenting an indicator report about two or more different processes.

In some cases, the risk self-assessment tool 310 may provide one or more user interface screens 318 that allow a user to enter create, delete and/or modify one or more key risk indicators and/or key control indicators. The risk self-assessment tool 310 may also be used to allow a responsible party, such as a risk manager, to validate and/or approve any changes, additions and/or deletions to the key risk indicators and/or key control indicators. The user interface screens 318 may further allow a user to update metrics associated with the indicators, such as assigning one or more different key risk indicators and/or key control indicators to a particular process and/or group of processes. The risk self-assessment tool 310 may collect the key risk indicator metrics and/or key control indicator metrics and use the collected metrics to generate a report, such as a monthly status report. The risk self-assessment tool 310 may further provide the indicator information for use in a monthly risk score card associated with a risk management project.

In an example, an illustrative method for editing key risk indicator and/or key control indicator information may include soliciting a request for a key risk indicator and/or a key control indicator to be assigned to a risk management project. For example, a manager, using the risk self-assessment tool 310, may cause the request to be sent to a user of the process subject to risk, such as by using an email, a text message, a phone message, an instant message, and/or the like. The request may identify the business process being evaluated and/or a control used to mitigate a risk associated with the business process. The user may then respond to the request with information that may be used to create an indicator. This response may include one or more different metrics that may be used to define at least one of a key risk indicator and a key control indicator. The risk self-assessment tool 310 may provide one or more user interface screens 318 to facilitate entry of this response. Once entered, key control indicator and/or the key risk indicator may be examined to determine whether the response was received in the correct format. If not, a new request may be sent.

When the response including the key indicator information (e.g., key risk indicator information, key control indicator information, metrics, and the like), has been validated and/or approved by a delivery team the risk self-assessment tool 310 may be configured to determine an action based on the received key indicator information. For example, the risk self-assessment tool 310 may determine whether the key indicator information corresponds to a new key risk indicator and/or a new key control indicator. If so, then a key indicator mapping screen may be presented to the user. The mapping screen may present process information and/or control information so that a user may select appropriate mapping details and hierarchy. For example, the metric mapping information screen may include one or more selection fields that may allow a user to map and/or assign the new metric to a particular process and/or hierarchy. For example, the fields may include an indicator mapping level (e.g., process, control, risk, and the like), a function (e.g., operations, enterprise functions, and the like), business information (e.g., a line of business, a business segment, a business unit, and the like), and/or a process, where the user may select a process from a list of entered processes.

The user may then select an “add new indicator” button that may trigger a different user interface screen to be displayed so that the user may enter details about the key risk indicator and/or the key control indicator. This information may be entered via fields presented on a user interface screen, which may include a key indicator type (e.g., risk, control, and the like), a data type (e.g., a number, an integer, text, and the like), a formula (e.g., a mathematical formula used to provide a value of the particular metric), a numerator and/or a denominator used when to evaluate the indicator metric, a frequency of use for the metric (e.g., monthly, weekly, yearly, and the like). In some cases, each key risk indicator may be paired with a corresponding key control indicator such that a relationship between the process risk and the control for mitigating the risk can be evaluated. In some cases, the user may be able to assign a key risk indicator to a particular key control indicator based, for example, on a particular business process that is being evaluated.

Once created, the risk self-assessment tool 310 may include one or more user interface screens 318 for entering information about a particular indicator metric. For example, a user interface screen may comprise a metric assessment questionnaire screen. This screen may include a status section for showing a status of the questionnaire, such as by indicating a total number of questions to be answered, an amount of questions that have already been answered, and/or information about a time and/or date when the questionnaire was edited and by whom. The questionnaire may further include a process information section that may include information about the process to which the metric has been assigned, such as a process name, a business unit, a business function, and the like, and/or an operational data section that may include a start date, a creation date, a roll out date, a rating, publication information, and/or the like. The questionnaire may include one or more different questions that may each correspond to a metric used to assign a value for the particular indicator to which the metric has been assigned. In some cases, the questionnaire may be used to enter metric information about a key risk indicator, a key control indicator or both the paired key risk indicator/key control indicator combination. The user may be prompted to input a value corresponding the particular metric being evaluated. In some cases, a historical metric value, that been previously entered, may be viewed. In some cases, a user may request to view historical metric data, such as a previous, or other, month's input values by selecting a button on the user interface screen 318. In some cases, a comment field may be available so that a user may enter one or more comments about individual metrics.

Once complete, the questionnaire may be submitted by the user to the risk/control indicator system 360, such as by selecting an input (e.g., a “submit” button) on the user interface screen. In some cases, multiple questionnaires may be communicated to the risk/control indicator system 360 at the same time. For example, the risk self-assessment tool 310 may allow for submission of two or more key risk indicator/key control indicator pairs to the risk/control indicator system 360, such as when the indicator pairs are associated with a same processes and/or risk management project. The risk self-assessment tool 310 may then communicate the questionnaire via the network to the risk/control indicator system 360.

The risk/control indicator system may then evaluate the different metric values provided via the questionnaire(s) to determine a score for each key risk indicator and key control indicator. The risk/control indicator system 360 may then provide the different scores to the reporting system 380 and/or the risk self-assessment tool 310 to generate a key risk indicator/key control indicator report. Such a report may be presented via a user interface screen 318 by the risk self-assessment tool 310. For example, a key risk indicator/key control indicator reporting screen may be presented as a table. For example, the table may include an indicator code column, and/or an indicator name column, for indicating a type of indicator (e.g., a risk indicator, a control indicator) and/or a function of the indicator, such as by using a descriptive name. In some cases, the table may have a numerator and a denominator column for showing a value of the numerator and denominator used when calculating the indicator score. For example, a number of metrics may be assigned as numerator metrics and a different number of metrics may be defined as denominator metrics. These metrics may be combined, such as by using a mathematical formula, to determine a numerator value and a denominator value. A score column may be used to display an indicator score that had been calculated by the risk/control indicator system 360 for each key risk indicator and key control indicator. In some cases, the report table may include a trigger column and/or a limit column. The trigger column may be used to specify a trigger point at which the indicator score may signal an escalation of a risk associated with the project, such as for a key risk indicator. In other cases, trigger value may indicate a point at which a particular control becomes more effective or less effective. As such, the triggers (e.g., a key risk indicator trigger, a key control indicator trigger, and the like) may be used to trigger an action plan that may escalate a risk priority or to trigger an action plan that may lessen a risk priority. For example, when a risk indicator trigger condition has been met, a user may define an action plan that may assign a different control for use in mitigating the risk. In some cases, when a control trigger condition has been met, the user may be prompted to evaluate whether the risk has been sufficiently mitigated so that the risk management project may be closed and/or whether the risk can be accepted. Another column may be used to define a limit for a particular indicator. The limits may be used, for example, to define a point at which a risk and/or use of its associated control may need to be reevaluated. The table may further include a column that indicates whether a predefined condition (e.g., a trigger condition, a limit condition) has been met or not met. The table may further include one or more columns that may describe a data source associated with the particular indicator metric, risk and/or control. For example, the data source column may include a reference to one or more reports, log sheets, dashboards, score sheets, and the like. In some cases, the table may provide a visual representation of a value and/or a status of the risk indicator metric and/or the control indicator metric. For example, if a metric has a high value, such as a value approaching a limit, the corresponding indicator may be colored (e.g., red). In some cases, if a metric has a sufficiently low value, such as an indication that an associated risk is low and/or that a control is working as expected, the corresponding indicator may be a different color (e.g., green). In some cases, such as when a score value is nearing a predetermined threshold, the corresponding indicator may be colored a third color (e.g., yellow, orange, or the like).

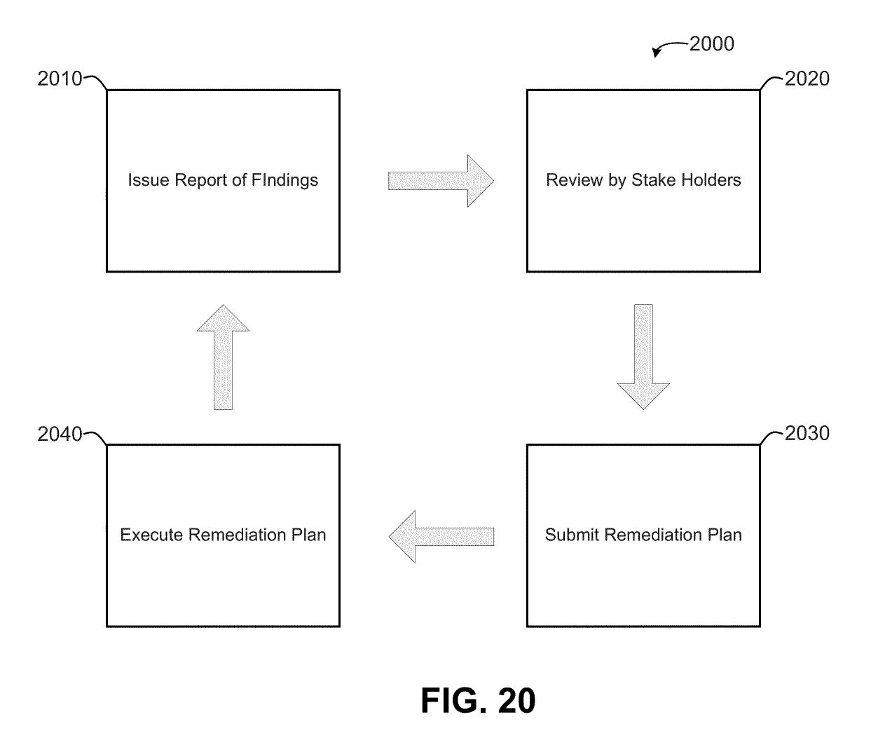

In some cases, the issue management system 330 may be used to implement a consistent workflow for a risk management project across different business units. For example, the issue management system 330 may provide a clear process for identifying, reporting and/or tracking an issue reported through the risk self-assessment tool 310, such as through a quality control test, a self-administered risk assessment, a presented risk score card, and/or the like. The risk self-assessment tool 310 may interface with the issue management system 330 to allow for investigation of an issue, escalation of an issue, and/or development of a remediation plan to apply to the issue. For example, FIG. 20 illustrates a sample workflow 2000 for a risk management process according to one or more aspects described herein.

At 2010, a report may be created, such as by the reporting system 380, to report information obtained through the investigation of an issue, such as the aforementioned quality control test, the self-administered risk assessment, and/or the presented risk score card. This report (e.g., a report of findings) may be presented to key stakeholders, management, senior leaders and/or risk partners, so that a decision may be made about any issue raised in the report. The report may include information about any risk issue that may be indicated in the report and one or more recommendations about remediating the issue. The report may further recommend a disposition for each issue that may have been raised. At step 2020, the report, and the information contained within, may be reviewed by the stakeholders, such as by using a user interface screen 318 of the risk self-assessment tool 310. In some cases, the stakeholders may review the report and present findings to management and/or risk partners. In other cases, the stakeholders may review the report with management and/or the risk partners. During the review, the stakeholders may discuss the findings and/or review any recommendations, such as for escalation and/or remediation plans. Once an agreement has been reached, the stakeholders may indicate an action plan to address the issue. For example, the stakeholders may view an issue assessment screen and enter information into the issue management system 330 according to their assessment of the issue. For example, the issue assessment screen may include a first section that is used to describe the identified issue, a second section that may be used to enter comments about the issue, such as an observation of the issue and/or any gaps noticed in the reporting data, and/or a third section for describing a likelihood that the risk issue may occur and/or an impact that the risk issue may have on the underlying business or business process.

For example, the first section may be used for entering so-called “static” data associated with the issue. This static data may include an assigned unique issue identifier, an identification of the affected business unit(s) and/or an identifier of an affected process. Further, the static data may identify a source from which the issue was identified, an assigned risk owner who may be responsible for performing a risk self-assessment in relation to this issue until resolved. The static data may further be used to identify countries in which affected business units may operate. In some cases, the static data may further include a selection as to whether the issue may have legal and/or regulatory impact on the business unit, a loss category, and/or and a listing of affected systems and/or assets. The static data may further be used to indicate an objective of an applied control used to mitigate the risk and/or an operational risk category (e.g., people, process, system, compliance, external events, and the like).

In some cases, the stakeholder may enter, via the issue assessment screen presented by the risk self-assessment tool 310, information about the how likely the identified risk is to occur when the controls are in place and/or about any impact that the risk would have on the performance of the business organization. For example, the stakeholder may choose between presented likelihood identifiers (e.g., rare, unlikely, possible, likely, almost certain, and the like) and/or possible impact levels (e.g., insignificant business impact, low business impact, moderate business impact, signification business impact, extreme business impact, and the like). The stake holder may then provide additional comments to further describe the selected likelihood and/or selected impact levels. To provide further information and/or documentation about the issue and/or a proposed control used to mitigate any risk associated with the issue, the stakeholder may attach one or more different files that may then be associated with the issue.

Once entered, the stakeholder may save the form as a draft, cancel entry of the form and/or submit the form into the issue management system 330, at 2030. Upon submission of a proposed remediation plan, the risk self-assessment tool 310 may generate an alert (e.g., an alert message) to be sent to an issue management team. The alert may include information about the identified issue and/or one or more proposed remediation plans. For example, options available to the issue management team may be to implement one or more remediation plans, to accept the risk, and/or to close the risk issue. If the risk is accepted, the issue management team may indicate a trigger and/or level at which the issue may be escalated. Once escalated, the issue may be re-assessed at 2020. To facilitate this process, the stakeholder may be presented with a user interface screen 318 via the risk self-assessment tool 310 to automate issue management process. For example, an issue risk management screen may allow the stakeholder to enter a listing of existing controls, and an associated description, that may be used to mitigate the risk associated with the issue. Further, the issue risk management screen may allow the stakeholder to define a degree of risk mitigation (e.g., high, medium, low, and the like) and/or a residual risk mitigation score. This residual risk mitigation score may be used to define a level at which the risk has been sufficiently mitigated. The issue risk management screen may further include an entry for a number of cycles (e.g., months) that a risk may be accepted and/or a number of cycles that a risk may be mitigated before re-evaluation of the risk. The stakeholder may further indicate a risk level associated with the issue, which may include levels such as severe, high, medium, low, and the like. The issue risk management screen may further allow the stakeholder to indicate whether the risk has been fully mitigated and to enter whether to accept the risk and/or to mitigate the risk, such as by using the indicated controls.

At 2040, a remediation plan may be implemented. For example, once the issue risk management screen has been submitted into the issue management system 330 using the risk self-assessment tool 310, a manager may review and/or validate the issue management plan, and optionally enter comments. If the issue is not to be closed, the selected remediation plan may be implemented and tracked until completion. For example, the risk self-assessment tool 310 may be used to monitor the activity and/or status of a risk management project managed by the issue management system 330. For example, the risk self-assessment tool 310 may communicate with the issue management system 330 and present a summary report via one or more user interface screens 318. For example, a summary report may identify the particular issue via a risk view section. The risk view section may include a risk summary, a risk description, and/or a risk reference number to identify the issue being reported. This section may further include the creator of the issue record, a risk owner (e.g., stakeholder), a creation data, and a date at which the issue is to be reviewed again by the issue management system. The current risk status may further be indicated, such as closed, active-accepted, active-controlled, or the like. For active issues, a listing of controls that may be used for mitigating any risk associated with the issue may be provided. For example, an “existing controls” field may list any active controls being used to mitigate the risk and/or an “additional controls” field may list different controls that may also be used for mitigating any risk associated with the issue. The summary report screen may further include information about the impact of the risk, a risk level associated with the issue, and/or a likelihood that the risk may occur.

In some cases, when an action is applied to the issue (e.g., close, accept the risk, mitigate the risk, and the like) via a user interface screen 318, the risk self-assessment tool 310 may generate an alert and/or a status email. For example, when an issue is to be closed, the risk self-assessment tool 310 may generate an email to send to an issue owner, a stakeholder, a manager, a risk partner, and/or other interested parties to indicate that any identified risk associated with the risk management project has been mitigated to an acceptable level. Similarly, when a risk has been accepted, the risk self-assessment tool 310 may generate an email to report that the risk has been accepted and when a control has been applied to mitigate the risk, an email may be generated to identify the risk, the process associated with the risk, and/or any controls that may be applied to mitigate the risk.

When determining a risk score associated with an issue, one or more scores may be associated with the information entered by the stakeholder, such as via the issue assessment screen presented by the risk self-assessment tool 310. In some cases, the risk self-assessment tool may provide information about the scores associated with particular selections that may be entered via the issue assessment screen. For example, if desired, the risk self-assessment screen may present a description of a particular field in which the possible selections may be described, as shown in the illustrative tables below.

TABLE 1
Criteria for Likelihood Calculation

| Likelihood | | | |
|---|---|---|---|
| rating | Description | Justification | Score |
| Almost | Risk is expected to occur | 3 events in 3 months or 4 | 5 |
| Certain | in most circumstances | events within 6 months | |
| Likely | Risk will probably occur | 4 events within 6 months | 4 |
| | in most circumstances | | |
| Possible | Risk might occur at some | 3 events in 3 months or 3 | 3 |
| | time | events within 4-6 months | |
| Unlikely | Risk could only occur | 1 event in 3 months or | 2 |
| | some time | twice within 4-6 months | |
| Rare | Risk may only occur in | Up to 1 event within 6 | 1 |
| | exceptional circumstances | months | |

TABLE 2
Criteria for Impact Calculation

| | Extreme | Significant | Moderate | Low | Insignificant |
|---|---|---|---|---|---|
| Sr. | Business Impact | Business Impact | Business Impact | Business Impact | Business Impact |
| No. | (EBI) | (SBI) | (MBI) | (LBI) | (IBI) |
| 1 | Potential impact ≧ | Potential impact ≧ | Potential impact ≧ | Potential impact ≦ | Potential impact ≦ |
| | x % of business | x % of business | y % of business | z % of business | v % of business |
| | revenue (e.g., | revenue (e.g., | revenue (e.g., | revenue (e.g., | revenue (e.g., |
| | about 10%) | about 10%) | about 15%) | about 5%) | about 1%) |
| 2 | Severe loss of | Serious loss of | Moderate loss of | Low loss of | Minimal loss of |
| | productivity | productivity | productivity | productivity | productivity |
| | (disruption | (disruption | (disruption | (disruption | (disruption |
| | affects ≧ x % of | affects ≦ z % of | affects ≧ y % of | affects ≦ w % of | affects ≦ w % of |
| | associates, e.g., | associates, e.g., | associates, e.g., | associates, e.g., | associates, e.g., |
| | x ≈ 30%) | z ≈ 10%) | y ≈ 10%) | w ≈ 5%)) | w ≈ 1%)) |
| | Systemic - | Systemic - | Min. financial | Min. financial | |
| | multiple business | functions or | impact - isolated | impact - isolated | |
| | units or systems | systems | to functions or | to function or | |
| | | | system | business unit | |
| 3 | Severe loss of | Serious loss of | Moderate loss of | Reputation under | Any challenge to |
| | reputation | reputation | reputation | threat | reputation |
| 4 | Financial charge | Potential for | Potential for | Potential for | Any |
| | from regulator | wide-ranging | investigation by | investigation by | potential for |
| | resulting from | investigation | regulator for a | regulator based | complaint to |
| | compromised | | specific non- | on compromised | regulator |
| | information | | compliance | information | |
| | | | event | | |

TABLE 3
Risk Owner Assessment for Degree of Risk Mitigation

| Degree of | | |
|---|---|---|
| Risk Mitigation | Description | Score |
| Near 0% | No controls in place. No risk mitigation. | 5 |
| About 20% | The score is determined by a subjective | 4 |
| About 40% | assessment by the risk owner | 3 |
| About 50% | | 2 |
| About 80% | | 1 |
| Near 100% | Risk nearly mitigated by controls in place. | 0 |

The degree of risk mitigation may be updated according to the level of control implemented by the risk owner. In some cases, the degree of risk mitigation may increase when additional and/or different controls are introduced. The additional controls may also lower the severity and/or impact of the risk on the process.

TABLE 4
Control Level Calculation

| Degree of | | | | | |
|---|---|---|---|---|---|
| Risk Mitigation | EBI | SBI | MBI | LBI | IBI |
| Near 0% | 10 | 9 | 8 | 7 | 6 |
| About 20% | 9 | 8 | 7 | 6 | 5 |
| About 40% | 8 | 7 | 6 | 5 | 4 |
| About 50% | 7 | 6 | 5 | 4 | 3 |
| About 80% | 6 | 5 | 4 | 3 | 2 |
| Near 100% | 0 | 0 | 0 | 0 | 0 |

When determining an issue rating, the issue tracking system may use one or more mathematical equations. In some cases, an issue rating calculation may be defined suing the control level and the likelihood scores. For example, an issue rating may be calculated as (issue rating)=(control level)×(likelihood)×2.

In some cases, the quality assurance system 370 may be used to define a “right sized” control environment and maintain an inventory of known risk and associated controls. The quality assurance system 370 may include a control inventory that may include information about known controls for mitigating risk encountered by the business. In some cases, the control inventory may be included as a part of the data repository 320 and/or as at least a portion of a different data repository. When configuring the quality assurance system 370, one or more quality team members may use the risk self-assessment tool 310 to define one or more risks that may be encountered by one or more business units of the organization and/or may define one or more controls that may be used to mitigate the identified risks. Once these risks and/or controls have been entered and/or stored in the data repository 320, a control grid may be defined for one or more processes that may be subject to a risk. For example, a quality team member may accesses a user interface screen 318 to assign controls used to mitigate the defined risks that a business unit may encounter. Once completed for two or more different business units the quality assurance system may aggregate the risks and/or controls to generate a composite inventory of known risks and their associated controls. Once created, these risks and controls may be used to generate one or more test plans executed by the quality assurance team to test the effectiveness of the risk management procedures put in place by the organization. The quality assurance team members may be assigned to test whether the controls may work as intended. Once performed, the quality team members may access a quality test screen on the user interface 316 of the risk self-assessment tool 310 to record the results of one or more quality control tests. The risk self-assessment tool 310 may be used to link the test results to any associated risk mitigation efforts being performed by the business.

A quality assurance test plan may include the steps of (1) identifying and/or documenting processes subject to risk, (2) identify and document controls that may be used to mitigate any identified risks that may be encountered by the different processes, (3) establish performance threshold and targets for all controls, (4) implement and maintain a scorecard to document the test results, and (5) develop a test plan for each identified control. When identifying and/or documenting processes subject to risk, procedures followed when implementing the process may be analyzed to determine risks that may occur during the operation of the process.

In some cases, the risk self-assessment tool 310 may present one or more user interface screens 318 that may be used to enter information into the control inventory. For example, a control inventory screen may be based on a control inventory template having a number of fields useful to describe the operation and/or function of a particular control. For example, the control inventory template may include a process field (e.g., a name of an applicable process), an organizational hierarchy field (e.g., business unit, line of business, sub-line of business, and the like), one or more critical business function fields, including a critical business function name field (e.g., a textual name for the business function), a critical business function description field (e.g., a textual description of the business function), a contact name field for the business function (e.g., a process owner), and/or a geographical location field (e.g., country name, region name, and the like). In some cases, the risk information may be entered using one or more data entry fields including, for example, an operational risk sub category field (e.g., a dropdown menu listing known risk sub-categories as defined by the business), a risk level field (e.g., a drop down list of known risk levels as defined by the business), a key risk inventory field and/or a divisional key risk inventory field (e.g., a link to a known risk stored in the data repository 320), an impact score field (e.g., an impact score from 1-5), a probability score field (e.g., a probability rating score from 1-5), a total score (e.g., impact x probability scores), a risk rating (e.g., a score calculated based on at least the probability score). In some cases, the control information may be entered using one or data fields presented via a user interface screen that may include, for example, a risk inventory control identifier and/or a divisional risk inventory control identifier field (e.g., a reference to a known control stored in the data repository 320), a control gap rating field (e.g., one or more ratings defined by the business unit that may be presented as a dropdown menu), a control type field (e.g., one or more control types defined by the business that may be presented as a dropdown menu), a control method field (e.g., one or more control methods defined by the business that may be presented as a dropdown menu), a control gap detail field (e.g., a textual description of the control gap), an issue reported field (e.g., a yes/no drop down menu), and/or a business function id (e.g., an identifier for a business function as defined by the business). In some cases, one or more other fields may be used including, for example control gap remediation (e.g., risk mitigation) fields, such as textual fields for entering remediation steps for the controls, a remediation owner (e.g., a name of a person responsible for managing a risk management process, and/or a target date for competing the remediation process. Other fields may include process level data fields (e.g., textual descriptions of a business process), a control procedure description field and/or a control statement field (e.g., one or more fields describing the use and/or function of a particular control), a control framework objective field (e.g., a description of a goal of a particular test case), a testing frequency field (e.g., optionally included to allow a user to enter a frequency for testing the control), a control frequency field (e.g., a field indicating how often to run a particular control that may be implemented as a dropdown menu having choices including daily, weekly, monthly, quarterly, annually, and/or as needed), and/or a key control field (e.g., yes/no selection as to whether this control is defined as a key control indicator).

In some cases, a control may be presented to a user via a user interface in a tabular format. Such tables may include one or more labels defining the control grid columns. Such labels may include, line of business, control grid ID, function, high risk process, mapping level, risk taxonomy, inherent risk, control objective ID (e.g., a link to a textual description stored in the data repository 320), control, metric/threshold, current performance, residual risk, QA scheduled, QC scheduled, scorecard, test plan, risk name, control description, control taxonomy, control type (level 2), control type (level 3) control responsible (e.g., a user responsible for managing the control), policies, policy standard, and/or procedures. The policies, policy standard and/or the procedures fields may include links and/or listings of any applicable business policies, standards and/or procedures corresponding to the control and/or the associated risk.

In some cases, the risk self-assessment tool 310 may present one or more user screens to enter a functional control plan into the quality assurance system 370. Such screens may be based, at least in part, on a functional control plan template that may include, for example, a functional control plan question field, a quality assurance attestation field, an explanation field, a risk library field, a control description field, a requirement filed, an Objective field, a test script field and/or a suggested metric field. In some cases, the function al control plan field may be used to identify a mechanism used to integrate different control management system components. The functional control plan may create a central testing plan repository that may provide standard controls and test steps to ensure substantive testing of the controls. The functional control plan may foster a culture of accountability by using one or more quality assurance and/o quality control procedures.

In some cases, the quality assurance attestation field may be implemented as a drop down menu including different selections that may include yes, no and not applicable (N/A). In some cases, a “yes” entry may be defined to mean that the control is in place and working as intended and is effective to mitigate a risk associated with the control. A “no” entry may be defined to mean that the control is in place, but is not effective or that the control has not been used to mitigate the associated risk, and a “n/a” entry may be defined as meaning the control does not apply to a particular process. In some cases, a waiver may need to be stored within the data repository 320 as a written explanation as to why the control does not apply. In some cases, the “explanation” field may be used to document a “no” or a “n/a” selection in the “quality assurance attestation” field.

In some cases, the risk library field may correspond to a consolidated risks developed by one or more business units and approved by a reviewing body within the organization. The risk library may be modified over time and may be used as a mechanism for standardizing risk identification and/or classification across different business units. The “control description” field may be used to describe a particular control function. For example, a control may be used to prevent risk events from occurring, while others may be used to determine why a risk event occurred, and/or to correct an effect resulting from a risk event. In some cases, a control may be defined as an automated control that may need minimal user interaction. Other controls may require more manual interaction to operate. The descriptions may be presented as a drop-down menu of standardized descriptors including “preventative controls”, “detective controls”, “corrective controls”, “automated controls”, and/or “manual controls”.

In some cases, the “requirement” field may be used to display a link to a policy, procedure and/or a regulation used when developing a particular control. The “objective” field may be used to display a statement of a desired result to be achieved when the particular control is used in a risk management project for a particular function and/or process. The “test script” field may be used to provide a detailed description of test scenarios and/or their expected result. These descriptions may be used to guide the tester through a testing event to ensure consistency between different executions of the testing event. In some cases, the testing scripts may be automated, manual, or a combination of automated sections and manual sections. The “metrics” field may be used to display metrics that may be used to ensure that the control is monitored effectively.

A workflow that may be defined to create a “right-sized” control environment for managing risk exposure of business processes across a business may be defined as (1) defining the business functions across the organization, (2) document the processes used to implement the different functions, (3) identify a risk exposure for the different business units based on the processes used to implement the business functions, and (4) apply controls appropriate to mitigating the identified risks. When identifying the functions of the different business units, the different identified functions may be associated with a business hierarchy and may be mapped to different processes used by the different business units to perform the functions. In some cases, the functions and process may be associated using one or more user interface screens provided by the risk self-assessment tool 310. For example, the risk self-assessment tool may access a data repository (e.g., the data repository 320) having known processes used by the organization's business units. Any associations between processes and the associated business units and/or business functions may be defined textually (e.g., data entry fields), graphically (e.g. a tree structure), and/or in a tabular format. As discussed above, risks may be associated with the processes, and in turn, the different functions and/or business units, and may be entered and/associated with appropriate metrics via one or more user interface screens 318. Similarly, the controls designed to mitigate an identified risk may be associated with one or more risks, processes, business units and/or functions using a user interface screen 318. Like the risks, control metrics and/or indicators may be defined for each control using the user interface screens 318. In some cases, the risks and/or controls may be organized as a risk library/control library within, for example, the data repository 320 to facilitate centralized access by the different business units and/or a quality assurance system by the risk self-assessment tool 310. Once entered, the a control grid may be maintained and/or viewed via one or more user interface screens 318 of the risk self-assessment tool 310.

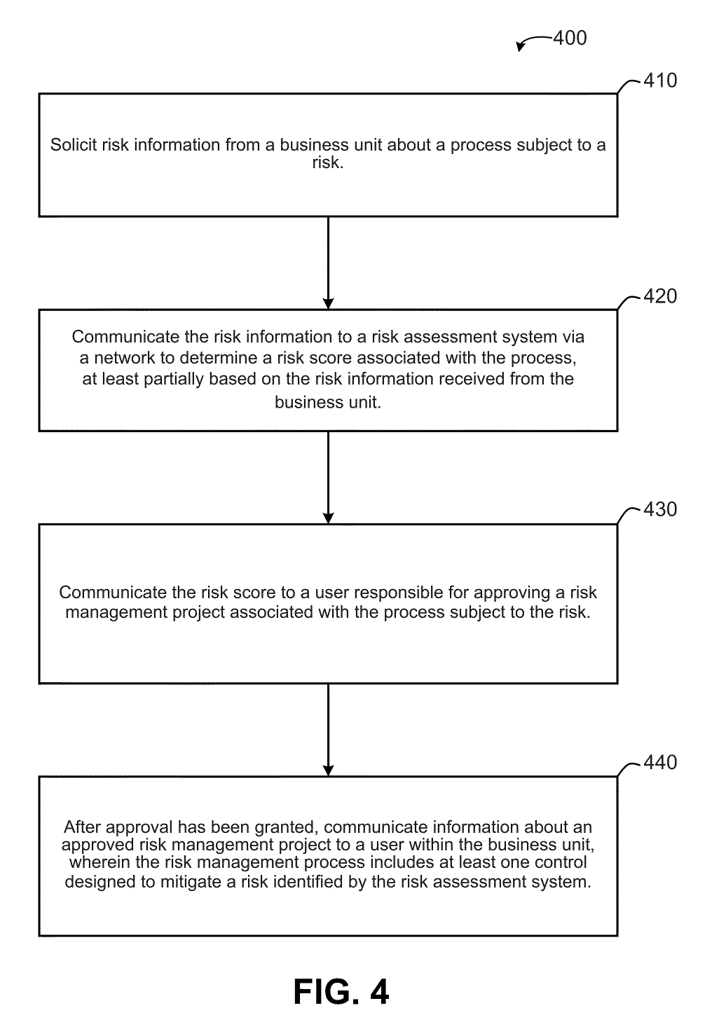

FIG. 4 illustrates a sample method of risk self-assessment of a process according to one or more aspects described herein. The method 400 for using a risk self-assessment tool 310 of a risk self-assessment computing device (e.g., server 101) may include, at 410, soliciting risk information from a business unit about a process subject to a risk and communicating the risk information to a risk assessment system via a network. At 420, a device within the risk assessment system 300, such as the risk analysis system 340 may be used to determine a risk score associated with the process based on the risk information received from the business unit. At 430, the risk self-assessment tool 310 may communicate the risk score to a user, such as via a user interface screen 318 displayed at the user's computer device 315, that may be responsible for approving a risk management project associated with the process subject to the risk. At 40, after approval has been granted, the risk self-assessment tool 310 may communicate information about an approved risk management project to a second user within the business unit, the risk management project including at least one control designed to mitigate a risk identified by the risk analysis system 340.

In some cases, the method 400 may include displaying, by the risk self-assessment tool 310, information about the risk management project via one or more user interface screens 318. The information may include at least a risk score associated with the risk management project. In some cases, the information about the risk management project may include a risk score associated with at least one of a risk associated with people participating in the business process subject to the risk, a risk associated with the business process, a risk associated with a system for implementing the business process, a risk associated with compliance to one or more policies regulating the business process and/or a risk associated with one or more events external to the business process.

In some cases, the method 400 may include displaying, by the risk self-assessment tool 310, information about two or more risk management projects via one or more user interface screens 318. The information may include at least one risk score associated with each risk management project. In some cases, soliciting risk information from the business unit about the process subject to risk at 410 may include presenting, by the risk self-assessment tool 310, a questionnaire to a first user via one or more user interface screens 318. In some cases, the questionnaire may be configured to solicit information about the business process subject to risk.

In some cases, the method 400 may include alerting, by the risk self-assessment tool 310, a second user (e.g., a manager) that business process information is available for review via one or more user interface screens after information about the business process has been entered by the first user. In some cases, the method 400 may include locking, by the risk self-assessment tool 310, the questionnaire when the business process information has been validated. The questionnaire may be locked before communicating the business process information to the risk assessment system via the network.

In some cases, the method 400 may include monitoring, by the risk self-assessment tool 310 using one or more user interface screens 318, a status of the risk management project over time. The risk self-assessment tool 310 may be configured to present the status of the risk management project one or more user interface screens providing a risk score card corresponding to the status of the risk management project. In some cases, the status of the risk management project may be in the form of a report generated by the reporting system 380. In some cases, the method 400 may include presenting, by the risk self-assessment tool 310, at least one user interface screen 318 that may display information describing one or more metrics that may be used to show a measure of a status of the risk management project. The metrics may include at least one of a compliance metric, a key risk indicator metric, and a key control indicator metric.

In some cases, the method 400 may include, at specified time intervals, soliciting, by the risk self-assessment tool 310, updated risk information from a business unit about the process subject to the risk. The risk self-assessment tool 310 may be configured to communicate the updated risk information to the risk assessment system 340 to determine an updated risk score in response to one or more controls used to mitigate the risk. The risk self-assessment tool 310 may then display a summary report corresponding to the risk management project using the one or more controls to mitigate the risk, wherein the summary report includes at least an updated risk score. In some cases, the risk self-assessment tool 310 may receive the report from the reporting system 380.

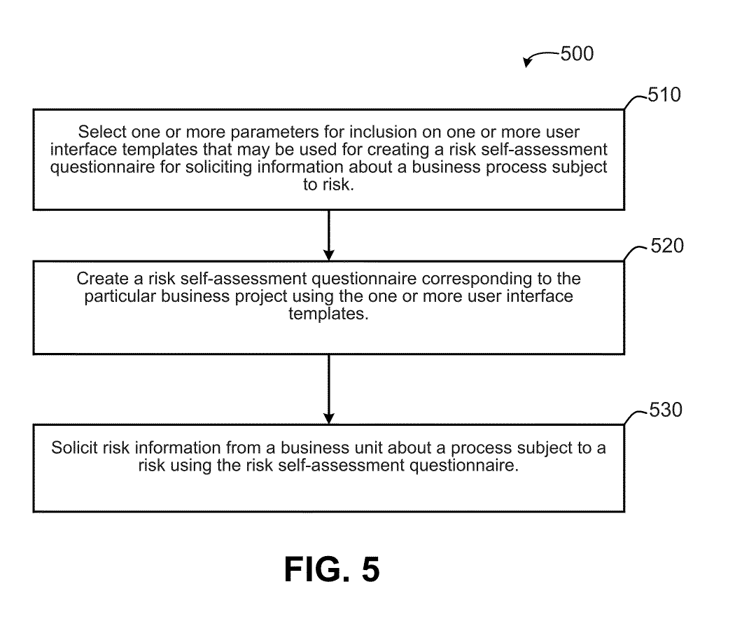

FIG. 5 illustrates a sample method 500 for configuring a risk self-assessment tool 310 to facilitate creation of a risk management project according to one or more aspects described herein. In some cases, the method 500 for configuring a risk self-assessment tool 310 of a risk self-assessment computing device (e.g., the server 101) for performing a risk self-assessment process may include selecting, via a template screen (e.g., a user interface screen 318) of a user interface device 316, one or more parameters for inclusion on one or more user interface templates. In some cases, the templates may be used for creating a risk self-assessment questionnaire for soliciting information about a business process subject to risk. The method may further include creating, via the user interface device 316, the risk self-assessment questionnaire corresponding to the particular business project using the one or more user interface templates.

In some cases, the method 500 may include selecting, via a template screen of a user interface device 316, one or more parameters for inclusion on one or more user interface templates, the templates used for creating a risk self-assessment questionnaire for soliciting information about a business process subject to risk. The method 500 may further include creating, via the user interface device 316, a risk self-assessment questionnaire corresponding to the particular business project using the one or more user interface templates. In some cases, the method may include assigning, via a user management screen of a user interface device, such as the user interface 316, roles to one or more users. The roles may correspond to a risk management function performed by the user. The user management screen may be presented via the user interface 316 associated with the risk self-assessment tool 310.

In some cases, the method 500 may include assigning, via the user management screen, a user to one or more risk management projects, wherein the user takes on an assigned role for the assigned risk management project. In some cases, the assigned role may include one or more user roles, such as, at least one of an administrator role, a risk manager role, and a quality assurance role.

In some cases, the method 500 may include requesting, by a key indicator screen of the user interface device 316, information about at least one of a key risk indicator and a key control indicator. The key risk indicator and/or the key control indicator may be used to measure and report a status of the risk management project and a control being used for mitigating risk associated with the risk management project. The user may then be able to validate, via one or more user interface screens 318 (e.g., a validation screen). The information may be entered to describe the operation of the key risk indicator and/or the key control indicator.

In some cases, the method 500 may include identifying, by a risk self-assessment tool 310, an action to be performed on one of the key risk indicator and the key control indicator. The action may be selected from one of creating the indicator, activating the indicator, deactivating the indicator, and/or modifying the indicator. In some cases, creating at least one of the one key risk indicator and/or the key control indicator may include selecting, via the validation screen, mapping information and/or hierarchy information that may be used when measuring a metric associated with the indicator. In some cases, the mapping information and hierarchy information may include at least one of a business function and a risk management project.

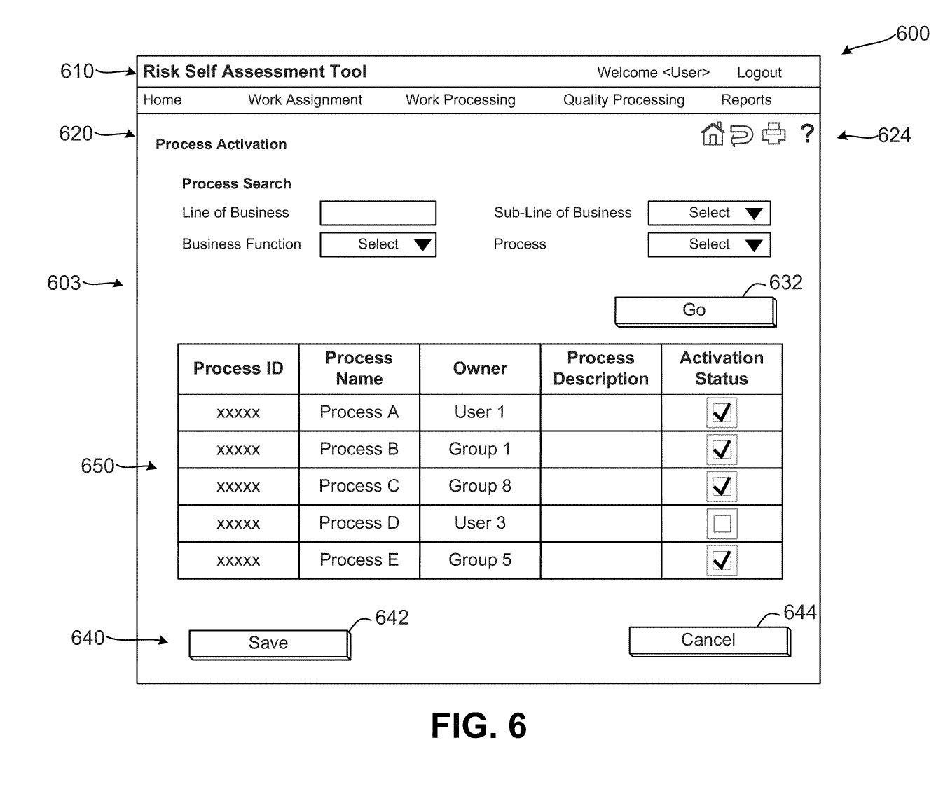

FIGS. 6-13 illustrate sample user interfaces 318 (e.g., the user interface screens 600, 700, 800, 900, 1000, 1100, 1200, and 1300) for configuring a risk self-assessment tool according to one or more aspects described herein. In some cases, information and/or instructions for creating, editing, and/or displaying one or more of the user interface screens 318 may be stored in the data repository 320. In some cases, the user interface screen 600 may include a title bar 610 that may identify the software application tool operating on a risk self-assessment computer device, such as the server 101. The title bar may include the name of the tool (e.g., risk self-assessment tool), a user name and/or one or more user functions, such as a log-out option. In some cases, a menu bar may be provided in a second section 720, such that one or more links to menu options may be provided, such as a home link, a work assignment link, a work processing link, a quality processing link and/or a reporting link. In some cases, by selecting these links, the risk self-assessment tool 310 may access information stored in the data repository 320 and/or provided by one or more of the issue management system 330, the risk analysis system 340, the compliance system 350, the risk/control indicator system 360, the quality assurance system 370, and/or the reporting system 380. In some cases, other menu options may be available for selection, such as a home button to return to a home screen of the risk self-assessment tool 310, a last page button, a print button and/or a help button. In some cases, a section 630 of the user interface screen 600 may be used to identify the function of the user interface screen 600. In this illustrative example, a process activation (e.g., a process management screen) may be indicated. The process activation screen may be configured to search for and/or display information about one or more business processes used to perform business functions of the organization. For example, the user interface screen 600 may include fields for identifying a line of business, a business function, and a sub-line of business and/or a process. A user may specify information in one or more of these fields and search for relevant processes that may be stored in the data repository 220 by pressing the button 632.

Results of the search may be displayed in the grid 650. A user may click on different entries to obtain information and/or provide information about that particular aspect of the process. For example, a user may be able to select an activation status for one or more different processes, such as by entering a selection in the “activation status” field associated with a particular process.

In some cases, the screen 600 may be provide after a user logs in with administrative rights into the risk self-assessment system 300 and selects a “process management” option. In some cases, the search function provided on the process activation screen 600 may be used to retrieve all process from the data repository 320 that match the entered search criteria. In some cases, the process status (e.g., shown in the “process activation” field) may be used to update the status of a particular process as “active” or “inactive”.

In an illustrative example, a user (e.g., an administrator), may cause the screen 600 to be displayed by selecting “process management” under a “master” menu filed on the menu bar. This screen may cause the process activation screen 600 to be displayed on a user's computer device 315, such as in a browser window. The user may search for a desired process using the search fields and activate and/or deactivate different processes via the “process activation” field. The user may save and/or cancel any changes made via this screen 600 using the buttons 642, 644.

In some cases, an error message may be needed, such as when an administrator attempts to deactivate a process that has not completed running. If the process is inactive in a master process data repository, a message may be shown, such as via a pop-up window, to prompt the user to activate and/or deactivate the process in the data repository 320 of the risk self-assessment system 300.

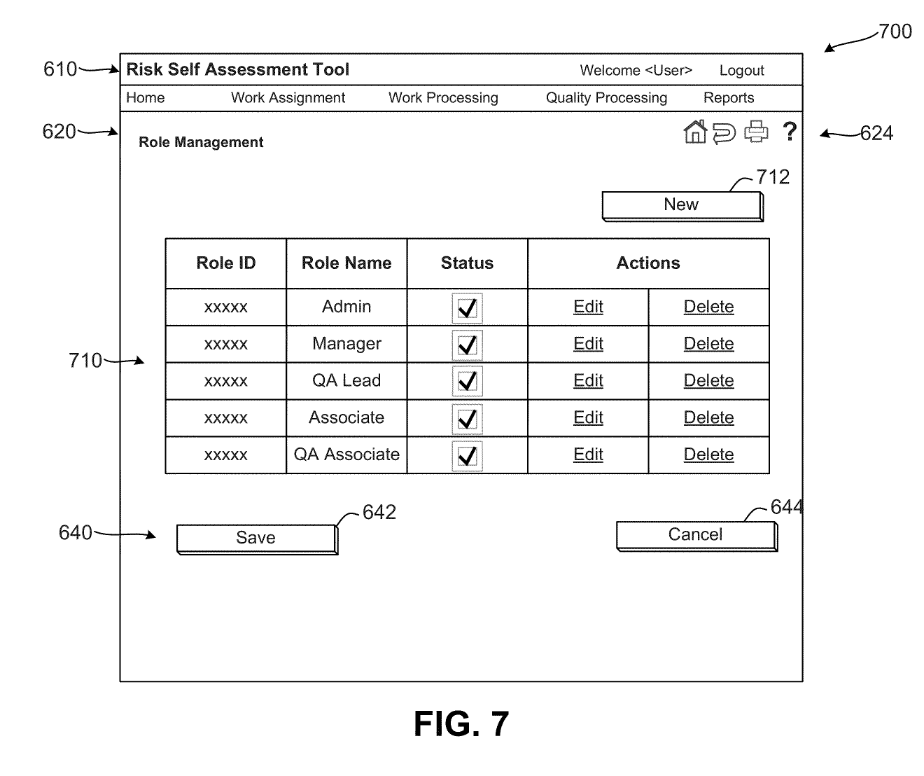

FIG. 7 shows an illustrative a role management user interface screen 700. The role management screen 700 may be used for managing system roles to users of the risk self-assessment system 300. For example, a user logged into the risk self-assessment system 300 as an administrator may access this page using a specified path (e.g., Master/Role Management). In some cases, the user may manage the roles defined for the risk self-assessment system 300, such as by adding a new role, deleting an unused role, and/or editing function performed by users assigned to the particular role. When the screen 700 is accessed, the roles defined for the system 300 may be displayed in the table 710. The table may include columns that display a system identifier assigned to a role (e.g., “Role ID”), a “role name” column, a “status” column, and/or one or more actions that may be performed on each role, such as “edit” or delete”. To add a new role to the table, the user may select the “new” button to display a dialog for entering information about the new role. Information about each role may be stored in the data repository 320. Each role name should be unique.

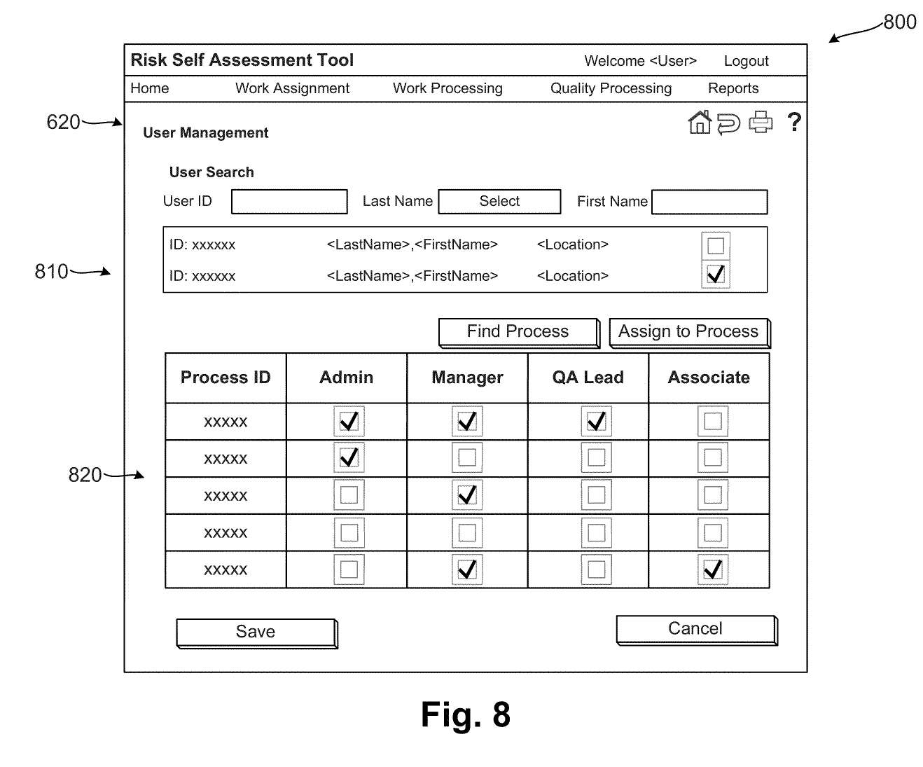

FIG. 8 shows an illustrative user management screen 800. The user management screen may be selected by a user logged-in to the system 300 as an administrator, such as by using the path “Master/User Management”. In some cases, the user may search for users based on a business unit, a line of business, a first name, a last name, a business function, a user identification number, a sub-line of business, and/or the like. A list of users found during the search may be displayed in the user table 810. The user information may be stored within the data repository 320.

In some cases, the different process may be may be searched using a pop-up window that appears after selecting the “find process” button. The administrator may be allowed to assign one or more roles and/or processes to individual users, that may be selected in the user table 810, such as by using selection buttons shown in the table 820. For example, a user may be assigned to one or more of an administrator role, a manager role, a quality role (e.g. a quality assurance lead role, a quality assurance associate), an associate role, and/or the like for each of the different processes displayed in the table 820. Once individual users are selected in the user table 810 and roles have been specified for particular processes displayed in the process table 820, the users may be assigned to the processes in the identified roles by using the “assign to process button”. The information may then be saved and/or canceled using the buttons 742, 744. In some cases, a user may be assigned to a shift, such as a day shift (e.g., 8 am-4 pm), an afternoon shift (e.g., 4 pm-12 am), and/or a night shift (e.g., 12 am-8 am) using one or more user interface screens, not shown.

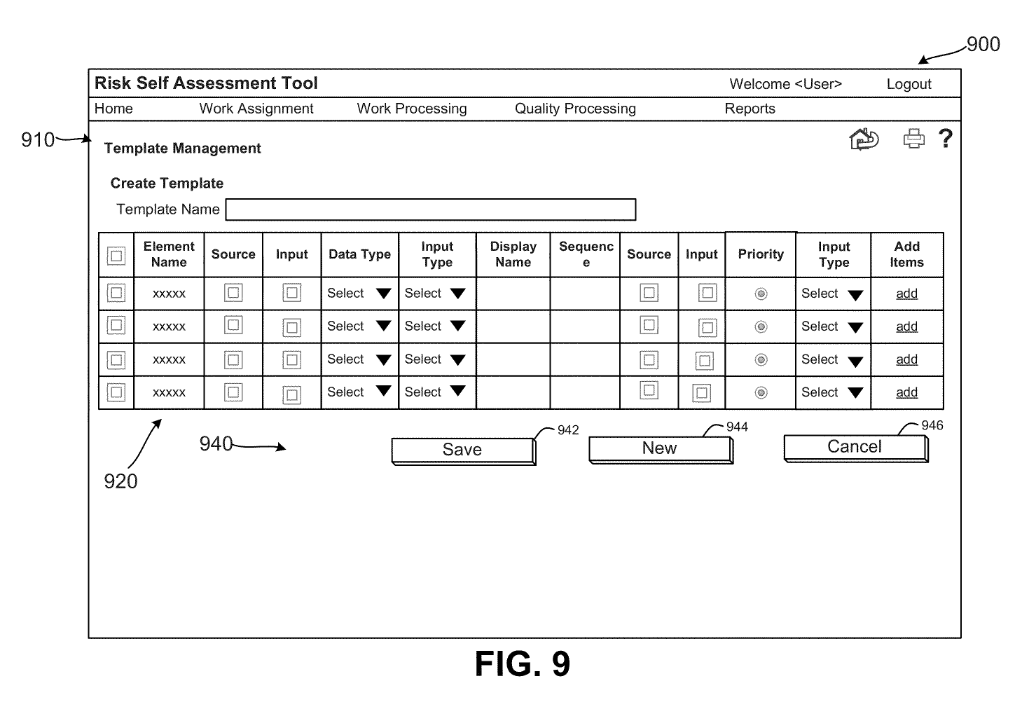

FIG. 9 shows an illustrative template creation screen 900. In some cases, a user having an administrative and/or a manager role may be capable of defining one or more templates for entering information about one or more processes and/or controls. In some cases, these templates may be used to create one or more of the questionnaires discussed above. The user may access the template creation screen via a path, such as “work assignment/template creation” on a menu of a user interface screen associated with the risk self-assessment tool 310. The template creation screen may be used to create a new template, add and/or remove elements to/from an existing template and/or to set features assigned to one or more fields, such as an input type and/or define one or more fields as being mandatory.

For example, the screen 900 may be displayed when a user selects a “generate data template” from a menu. The user may then specify a template name and be able to add elements to the template using an “add new element” selection, which may be accessed via a menu option. IN some cases, the user may be capable of adding a description to describe the use of the template being created. Once completed, the template may be saved to the data repository 320 for future use. Elements desired to be included in the template may be displayed in the element table 920. Each element may be associated with one or more attributes. For example, a source attribute may correspond to a data elements associated with transactional data received from business sources (e.g., a loan number, a mortgage amount, and the like). An input attribute may be selected to show whether the associate should add the input while processing the transaction. An input type attribute may be used to define a type of the input that will be entered (e.g., a loan identifier may be an integer or alphanumeric). A data type attribute corresponds to data elements for which the associate may enter a value while working on a transaction. The administrator may define the appropriate field type, such as a text box, a list box, an option button, and/or the like based on the data to be entered, such as a comment field, a start time, an end time, that may be associated with a transaction with the risk self-assessment system 300. If a data type requires field entries (e.g., a list data type), the necessary list element must be entered to be displayed in the list. A sequence element, defines an arrangement order for the data elements as they would appear on the final user interface screen 318. The order may be selected to provide easy navigation.

The priority field may be used for selecting a parameter to prioritize transactions to be processed by an associate in the risk self-assessment system 300. For example, the transactions may be ordered based on the age of the transaction. The data element that may define a factor for aging may need to be selected. The mandatory field may be used to define a particular element as being a mandatory entry field. A data format field may be used to define the data format of the data element, such as numeric, text, date, time, and the like. A unique ID field may be used to define a unique identifier to easily identify a particular transaction. This may be defined by the administrator while mapping the data elements for a process (e.g., transaction ID, loan number, and the like). A format element may be used to define the format for the data element (e.g., date format, real number format, and the like). In some cases, the add item entry may be used to add different data elements to the element table 920. In some cases, different elements may be mandatory entries, such as the source element, input element, sequence element, priority element, and/or element name.

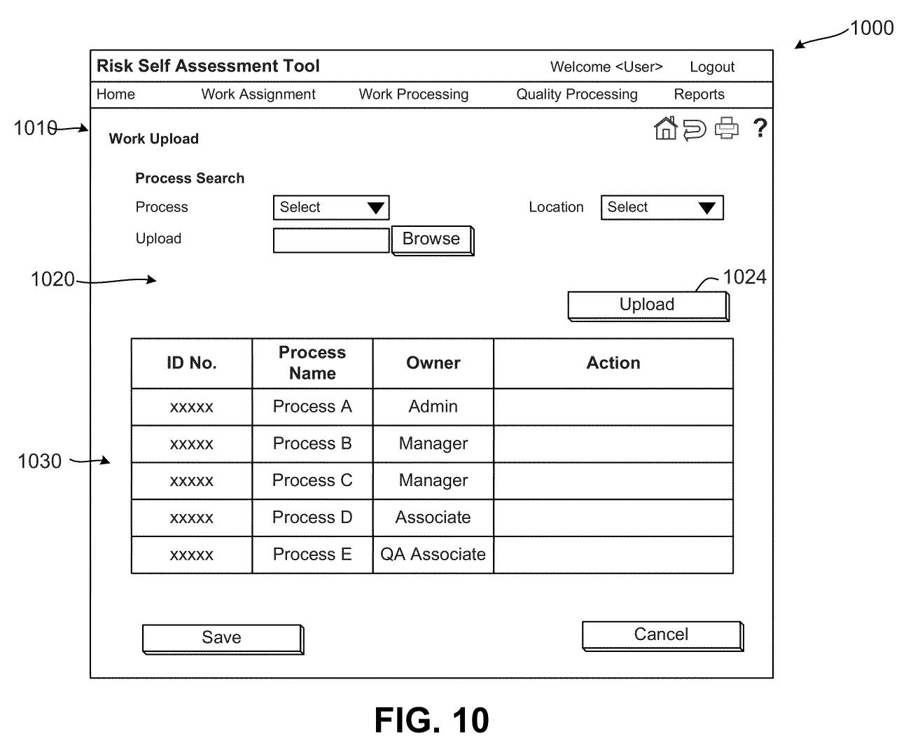

FIG. 10 shows an illustrative work upload user interface screen 1000. In some cases, this screen 1000 may be accessed by selecting a “work upload” option in the main menu of the risk self-assessment tool 310. A user may browse to and/or upload a file (e.g., a spreadsheet, a text file, and the like) that may contain information about one or more transactions. By selecting upload, the information may be displayed in the grid 1030. The administrator may verify the data based upon one or more business rules.

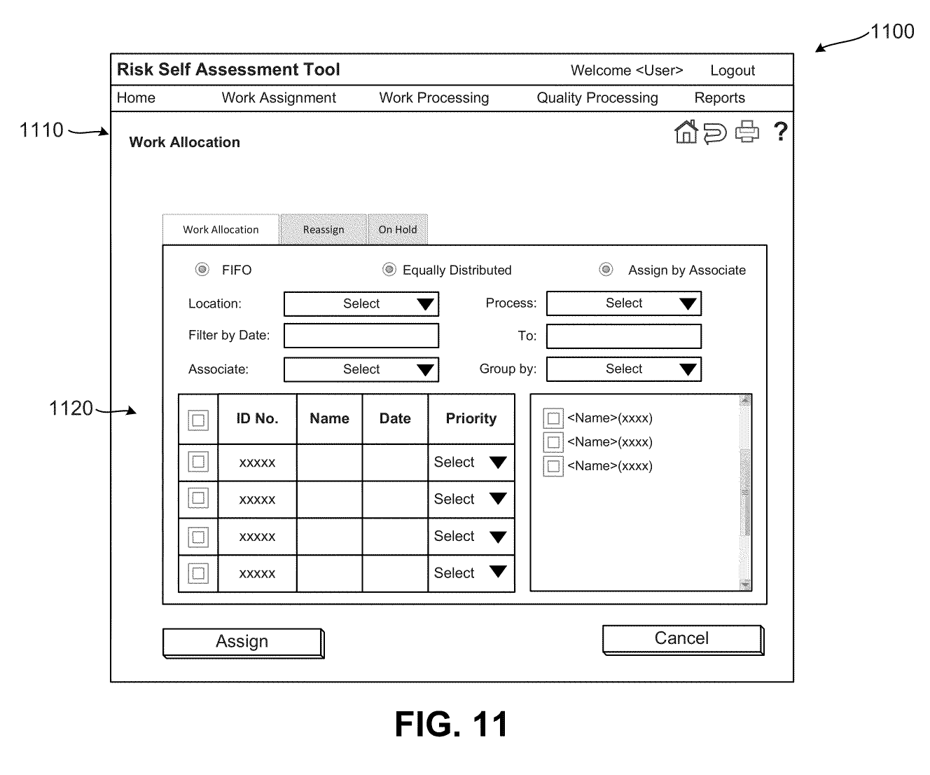

FIG. 11 shows an illustrative work allocation screen 1100. The work allocation screen 1100 may be used to provide the manager to specify specific processes and/or transactions on hold pending clarification that may be entered by a user. The manager may be able to view all associates that may be assigned to a particular process and/or other associates that may be allowed to be assigned for work allocation purposes. In some cases, the associates may be grouped by location. The manager can allocate work based on one or more different methods (e.g., first in-first out, skill based allocation, equal distribution, and the like). This screen 1100 may be displayed in a user's browser by the risk self-assessment tool 310 when selecting “work allocation” from the work assignment menu. A manager may select the wok allocation type from a radio button. The manager can filter the transaction based on a group selection, a location selection, a process selection, a date selection, a “assign by associate” selection, and/or a unique identifier selection. The manager may be able to select the transaction from the transaction grid and associate from the associate list, in selection portion 1120 of the screen 1100. The manager may assign the user to a particular transaction depending on the work allocation type. In some cases, the manager may assign and/or reassign the work allocation any number of times.

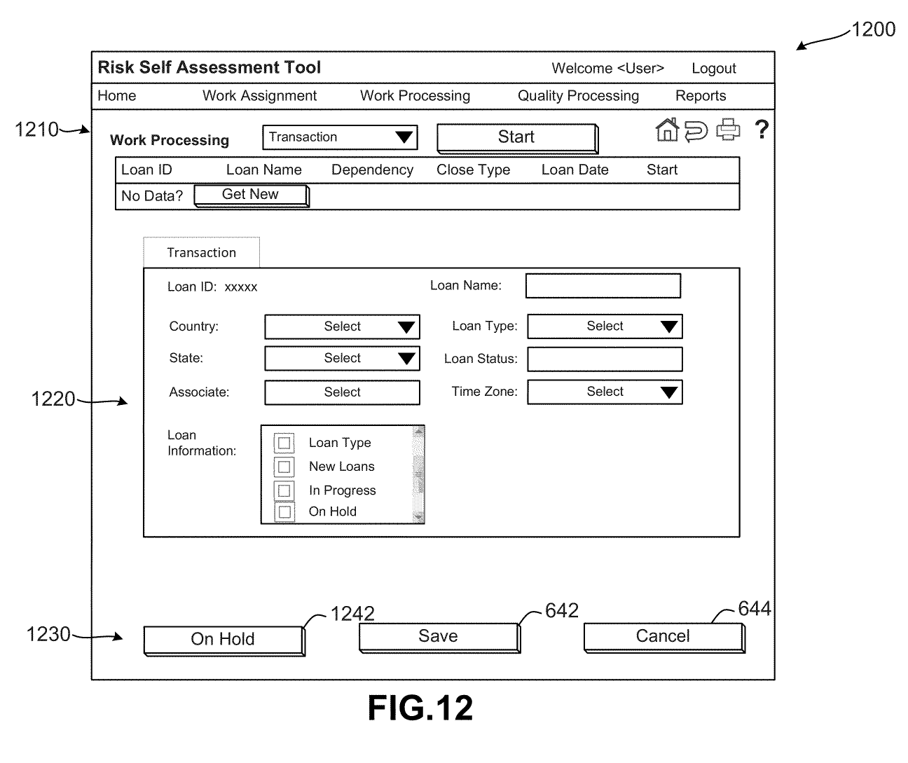

FIG. 12 shows an illustrative work processing user interface screen 1200. In some cases, a manager may log into the risk self-assessment tool 310 and select the work processing interface, such as by using the path “work assignment/work allocation”. The work processing user interface screen 1200 may be used to allow the manager to put specific transactions on hold for further clarification. The manager may select the work allocation type by using a radio button. The manager may filter the transaction based on a group, process, date, associate assignment and/or identification. In some cases, the manager may select a transaction from the transaction grid and an associate from an associate grid. The by clicking on the assign button, the manager may assign the work to the associate depending upon the work allocation type. The manager may reassign the work by a similar process.

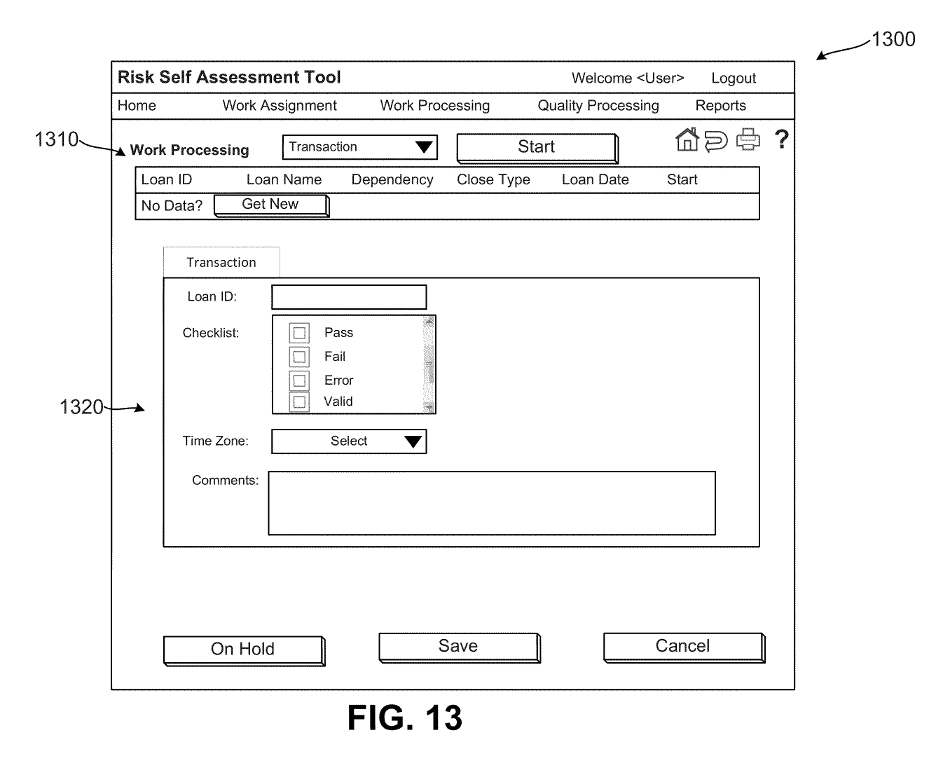

FIG. 13 shows an illustrative quality assurance work processing user interface screen 1300. In some cases, the quality process may use one or more similar user interface screens. For example, the user interface screen 1300 may be used by a quality assurance associate to complete a transaction. For example, the quality assurance associate may log into the risk self-assessment tool 310 and may have an option to choose between a primary process and a secondary process, if assigned to more than one process, to start work. The quality assurance associate may be able to update a status (e.g., quality verified, on-hold, and the like) of each transaction before submission and/or saving work. The associate may select a transaction and according to a quality template, different controls may be positioned on the user interface screen. In some cases, the associate may verify the transaction by updating a checklist (e.g., pass, fail, error, valid, and the like), and may be able to enter any desired comments about the work.

FIGS. 15-19 illustrate sample user interface screens for facilitating creation of a risk management project according to one or more aspects described herein. In a first step, a risk manager may publish a questionnaire, such as by using a publish process template user interface screen 1500 of FIG. 15. The template user interface screen 1500 may include a section 1520 for finding a process. The user may search for a process by using different search criteria, such as a line of business, a business function, a responsible person, a sub-line of business and/or a process name and/or process ID. After the search has been completed, one or more different templates matching the search criteria may be displayed in a grid 1530. The processes may be edited and/or published using the screen 1500. In some cases, the templates may be published by selecting a check box associated with a template. In some cases, a total number of templates, a number of published templates and/or a number of unpublished templates may be indicated on the grid 1530. In some cases, the user may be capable of navigating a list by selecting a page at the page selection 1540.

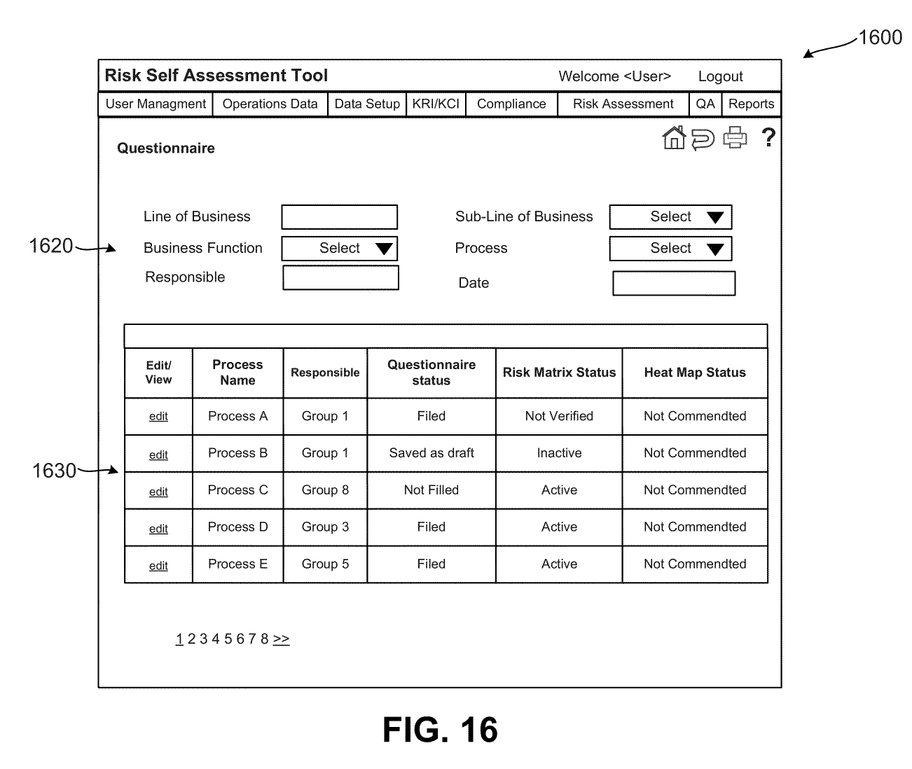

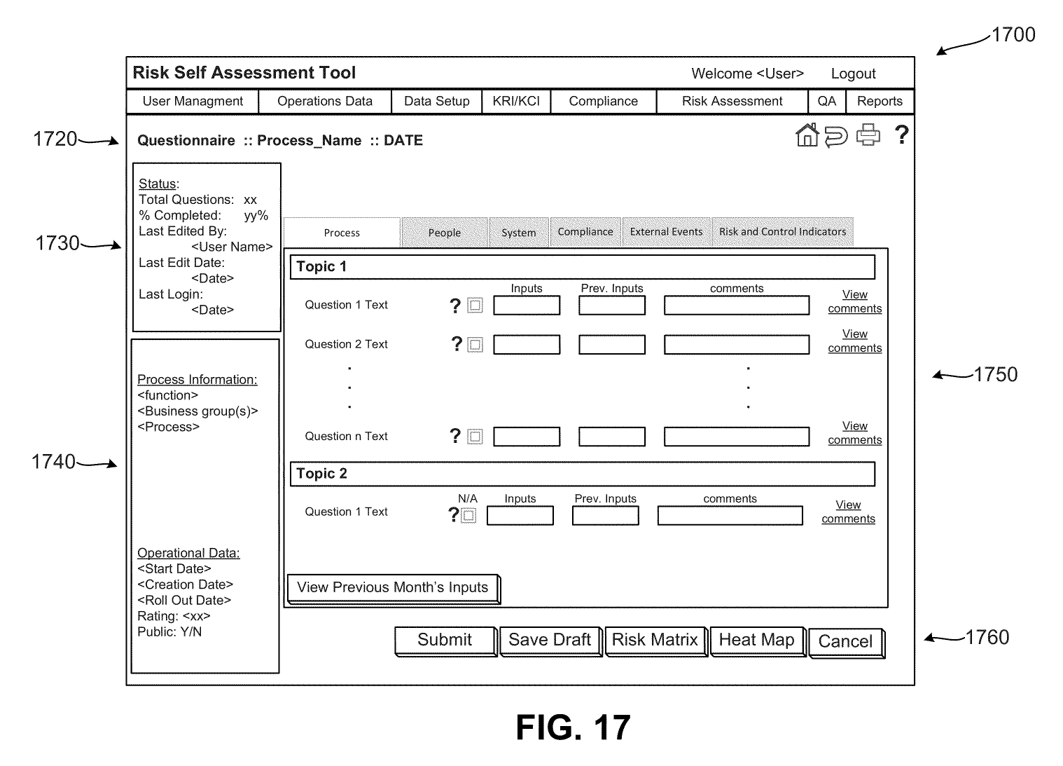

At a next step, an associate may access a questionnaire, by selecting a particular questionnaire associated with a process, such as by selecting an edit option, as shown in the questionnaire screen 1600 of FIG. 16. A grid 1630 may show a process name, a responsible group associated with the process, a questionnaire status (e.g., filed, saved as draft, not filed, or the like), a status of a risk matrix and/or a status of a heat map associated with the process. FIG. 17 shows an illustrative questionnaire screen 1700 that may be associated with a particular process, as indicated in section 1720. A status section 1730 of the questionnaire may be viewed. For example, the status section 1730 may list a total number of questions, an indication of how many questions have been completed, one or more edit dates, and/or a login date. An information section 1740 may list information about the process (e.g., a function, one or more business groups, a process, and the like), and/or operational data (e.g., a start date, a creation date, a roll out date, a rating, and/or an indication of publication). In the questionnaire section, one or more tabs (e.g., process, people, system, compliance, external events, and risk and control indicators) may be used to display questions used to gather information about the process and/or the controls being used to mitigate the process. In some cases, questions associated with each tab may be grouped by topic (e.g., financial loss, process effectiveness, process efficiency, and/or the like.). Once the questionnaire has been completed, the user may submit the questionnaire, save a draft, generate a heat map and/or generate a risk matrix. In some cases, the user may cancel any edits without saving. The same questionnaire screen 1700 may be used monthly to enter information about the risk and/or controls used during a risk management project. The user may view inputs from a previous entry, either in fields associated with a question and/or by selecting a button that may allow a user to view data from a selected month. The questionnaire may include one or more questions, an information button to provide further details explaining the question, a selection box to indicate whether the question is not applicable to a particular process, an input value, a display of a previous input value and a comment field. A user may select an input to view comments from one or more different entries about each question.

FIG. 18 shows an illustrative risk matrix screen 1800 that may be accessed, such as by a risk manager. The risk manager may review information presented in the risk matrix and validate the matrix. For example the risk matrix screen 1800 may include a process information section that may include a listing of information associated with the process corresponding to the risk matrix. In some cases, the user may view and/or hide the information from view. The risk matrix section 1840 may include a risk score and a table detailing the risk values assigned for different categories (e.g., people, process, and the like). The risk matrix may list parameters and any associated weightings used when calculating a risk score. In some cases, the weighting may default to 100%. In other cases, the weightings may be specified by a user, administrator, or the like. The table may list a parameter, and a parameter rating, a category and a category weighting, and a listing of questions associated with each parameter. Each question may include a weighting, an indication of applicability, and/or a number of inputs associated with a rating. In some cases, the risk matrix section 1840 may include an impact score, a likelihood score and/or an exposure score for each of the questions. In some cases, the manager may validate the complete risk matrix and/or a portion of the matrix (e.g., a question, a parameter, and the like). The user may further view a questionnaire, reject a questionnaire, export the risk matrix to a file, view a previous risk matrix, view a current heat map, view a previous heat map, submit the data, save a draft of the data and/or cancel any edits.

FIG. 19 shows an illustrative heat map 1900. The heat map may include a risk score associated with the risk management project. He hat map may illustrate scores associated with the different parameters associated with the different processes. The heat map section 1930 may include a process name column listing the processes, and a column associated with each parameter associated with the different processes. The parameters may include people, process, system, compliance, external events and/or others. A risk score may be calculated from the answers to the questions listed under each parameter section on the questionnaire. In some cases, the heat map section 1930 may include an overall risk score associated with the individual processes. The heat map may include a visual representation of a “heat” associated with the scores. For example, scores under a first threshold (e.g., low scores) may be colored with a first color (e.g., green) illustrating a low heat level, a score within a second range may indicate a medium heat level and may be colored with a different color (e.g., yellow) and higher scores, above a specified threshold may indicate a high risk associated with the process and may be colored with a third color (e.g., red).

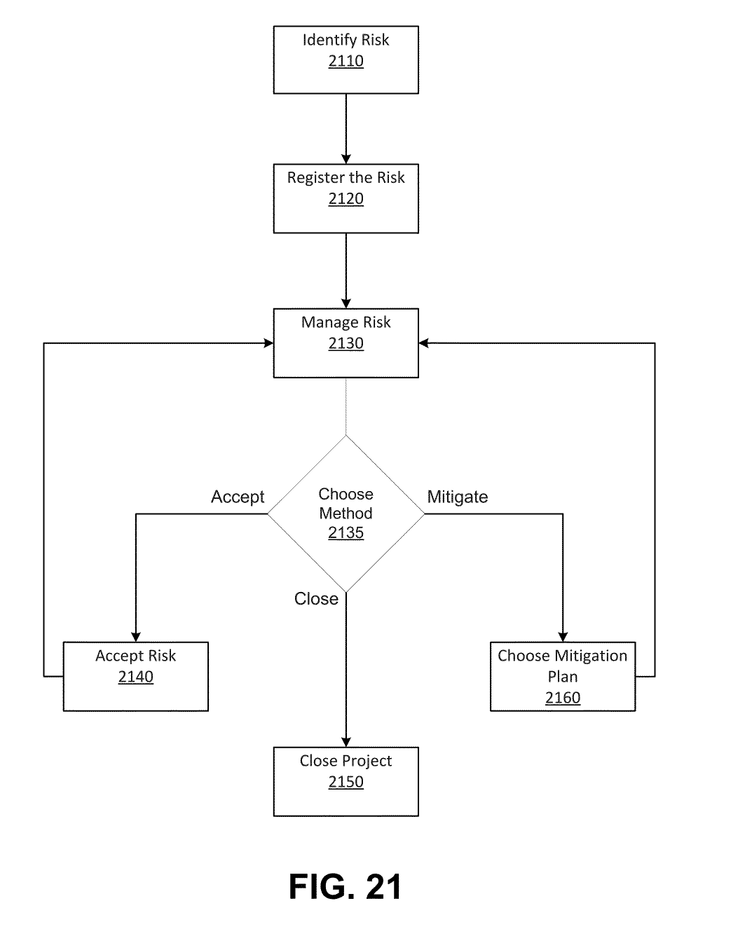

FIG. 21 illustrates a sample method 2100 for managing a risk according not one or more aspects described herein. At 2110, a user may identify a risk associated with a process, such as by entering information into a questionnaire using a first user interface screen of the risk self-assessment tool 310. At 2120, the user, or a manager, may register the risk in the risk management system 300, such as by storing the information into the data repository 320. Once entered, one or more users may create a risk management project such as by assigning one or more controls that may be used to mitigate the risk. In some cases, the users may decide an action to be done to manage the risk associated with the risk management project associated with the process, at 2135. For example, a user may choose to accept the risk at 2140. In such cases, the risk may be determined to be within an acceptable level, so that the manager may decide to monitor the risk to see whether an control would be necessary to be implemented. The risk management process would continue to manage the risk at 2130, such as by prompting a responsible party to fill out the questionnaire at specified time intervals (e.g., monthly). The questionnaire entries would then be evaluated to determine a next action at 2135. If, at 2135, the user may decide on implementing a risk mitigation plan by applying one or more controls capable of mitigating an identified risk at 2160. The risk management project would then continue to manage the risk at 2130. If, at 2135, the risk has been found to be sufficiently low (e.g., under a closure threshold) the risk manager may close the project at 2150.

Although not required, one of ordinary skill in the art will appreciate that various aspects described herein may be embodied as a method, a data processing system, or as a computer-readable medium storing computer-executable instructions. Accordingly, those aspects may take the form of an entirely hardware embodiment, an entirely software embodiment or an embodiment combining software and hardware aspects. For example, a computer-readable medium storing instructions to cause a processor to perform methods in accordance with aspects of the disclosure is contemplated.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the elements of the aforementioned embodiments may be utilized alone or in combination or sub-combination with elements of the other embodiments. It will also be appreciated and understood that modifications may be made without departing from the true spirit and scope of the present disclosure. The description is thus to be regarded as illustrative instead of restrictive on the present disclosure.

What is claimed is:

1. A method comprising:
selecting, via a template screen of a user interface device, one or more parameters for inclusion on one or more user interface templates, the one or more user interface templates are configured to create a risk self-assessment questionnaire for soliciting information corresponding to a business process subject to risk; and
creating, via the user interface device, a risk self-assessment questionnaire corresponding to the business process using the one or more user interface templates.

2. The method of claim 1, comprising:
assigning, via a user management screen of the user interface device, roles to one or more users, the roles corresponding to a risk management function performed by the user and wherein the user management screen is presented via a user interface device associated with a risk self-assessment computer device.

3. The method of claim 2, comprising:
assigning, via the user management screen, a user to a user role associated with one or more risk management projects, wherein the one or more risk management projects include tasks assigned to a particular user role.

4. The method of claim 2, wherein the roles include at least one of an administrator role, a risk manager role, and a quality assurance role.

5. The method of claim 1, comprising:
requesting, by a key indicator screen of a user interface device, information corresponding to at least one of a key risk indicator and a key control indicator, the key risk indicator and the key control indicator for measuring and reporting a status of a risk management project subject to a control and wherein a control is used for mitigating risk associated with the risk management project;
creating at least one key risk indicator and key control indicator; and
validating, via a validation screen, the information entered about the key risk indicator and the key control indicator.

6. The method of claim 5, comprising:
identifying, by a risk self-assessment tool, an action to be performed on one of the key risk indicator and the key control indicator, the action selected from one of creating the indicator, activating the indicator, deactivating the indicator, and modifying the indicator.

7. The method of claim 5, wherein creating at least one of the one key risk indicator and the key control indicator comprises:
selecting, via the validation screen, mapping information and hierarchy information used when measuring a metric associated with the indicator, the mapping information and hierarchy information including at least one of a business function and a risk management project.

8. A system comprising:
a user interface device having one or more user interface screens; and
a risk self-assessment computer device communicatively coupled to the user interface device, the risk self-assessment computer device comprising a processor and a non-transitory memory in communication with one or more of the user interface device and the processor, the non-transitory memory storing instructions that, when executed by the processor, cause the risk self-assessment computer device to:
select, via a template screen, one or more parameters for inclusion on one or more user interface templates, the templates used to create a risk self-assessment questionnaire used to solicit information corresponding to a business process subject to risk; and
present, via the user interface device, a risk self-assessment questionnaire corresponding to the business process based on the one or more user interface templates.

9. The system of claim 8, wherein the non-transitory memory stores instructions, that when executed by the processor, cause the risk self-assessment computer device to:
assign, via a user management screen of the user interface device, user roles to one or more users, the user roles corresponding to a risk management function performed by the user and wherein the user management screen is presented via a user interface of a risk self-assessment computer device.

10. The system of claim 9, wherein the non-transitory memory stores instructions, that when executed by the processor, cause the risk self-assessment computer device to:
assign, via the user management screen, a user to one or more risk management projects, wherein the user takes on an assigned role for the one or more risk management projects.

11. The system of claim 9, wherein the user roles assigned to the one or more users includes at least one of an administrator role, a risk manager role, and a quality assurance role.

12. The system of claim 9, wherein the non-transitory memory stores instructions, that when executed by the processor, cause the risk self-assessment computer device to:
request, by a key indicator screen, information corresponding to at least one of a key risk indicator and a key control indicator, the key risk indicator and the key control indicator for measuring and reporting a status of a risk management project and a control being used for mitigating risk associated with the risk management project; and
validate, via a validation screen, the information entered about the key risk indicator and the key control indicator.

13. The system of claim 12, wherein the non-transitory memory is stores instructions, that when executed by the processor, cause the risk self-assessment computer device to:
identify an action to be performed on one of the key risk indicator and the key control indicator, the action selected from one of creating the indicator, activating the indicator, deactivating the indicator, and modifying the indicator.

14. The system of claim 12, wherein the non-transitory memory is stores instructions, that when executed by the processor, cause the risk self-assessment computer device to:
selecting, via the validation screen, mapping information and hierarchy information used when measuring a metric associated with the indicator, the mapping information and hierarchy information including at least one of a business function and a risk management project.

15. The system of claim 12, further comprising an indicator system communicatively coupled to the risk self-assessment computer device, the indicator system configured to:
measure a metric associated with an activated key risk indicator associated with a risk management project; and
measure a metric associated with an activated key control indicator associated with the control used to mitigate risk.

16. One or more non-transitory computer readable media having computer-executable instructions stored thereon that, when executed by one or more computers, cause the one or more computers to:
select, via a template screen of a user interface device, one or more parameters for inclusion on one or more user interface templates, the one or more user interface templates configured to create a risk self-assessment questionnaire for soliciting information corresponding to a business process subject to risk; and
create, via the user interface device, a risk self-assessment questionnaire corresponding to the business process using the one or more user interface templates; and
solicit risk information from a business unit corresponding to the business process subject to the risk using the risk self-assessment questionnaire.

17. The computer readable media of claim 16, further having computer-executable instructions stored thereon that, when executed by one or more computers, cause the one or more computers to:
assign, via a user management screen of the user interface device, roles to one or more users, the roles corresponding to a risk management function performed by the user and wherein the user management screen is presented via a user interface of a risk self-assessment computer device.

18. The computer readable media of claim 17, further having computer-executable instructions stored thereon that, when executed by one or more computers, cause the one or more computers to:
assign, via the user management screen, a user to one or more risk management projects, wherein the user takes on an assigned role for an assigned risk management project.

19. The computer readable media of claim 16, further having computer-executable instructions stored thereon that, when executed by one or more computers, cause the one or more computers to:
request, by a key indicator screen of a user interface device, information about at least one of a key risk indicator and a key control indicator, the key risk indicator and the key control indicator used to measure and report a status of a risk management project and a control being used to mitigate risk associated with the risk management project; and
validate, via a validation screen, the information entered corresponding to the key risk indicator and the key control indicator.

20. The computer readable media of claim 16, further having computer-executable instructions stored thereon that, when executed by one or more computers, cause the one or more computers to:
identify, by a risk self-assessment tool, an action to be performed on one of a key risk indicator and a key control indicator, the action selected from one of creating an indicator, activating the indicator, deactivating the indicator, and modifying the indicator.
